(19) United States
(12) Patent Application Publication
(10) Pub. No.: US 2026/0351688 A1
(43) Pub. Date: Nov. 5, 2026

(54) SEPARATOR FOR SECONDARY BATTERY, AND SECONDARY BATTERY COMPRISING SAME

(71) Applicant: SAMSUNG SDI CO., LTD., Yongin-si, Gyeonggi-do (KR)

(72) Inventors: Byungsoo KIM, Yongin-si, Gyeonggi-do (KR); Soohee KIM, Yongin-si, Gyeonggi-do (KR); Hana KIM, Yongin-si, Gyeonggi-do (KR)

(73) Assignee: SAMSUNG SDI CO., LTD., Yongin-si, Gyeonggi-do (KR)

(21) Appl. No.: 18/995,400

(22) PCT Filed: Mar. 21, 2024
(86) PCT No.: PCT/KR2024/003562

§ 371 Date: Jan. 16, 2025

(30) Foreign Application Priority Data
Mar. 26, 2023 (KR) 10-2023-0039341
Apr. 28, 2023 (KR) 10-2023-0056577

(51) Int. Cl. H01M 10/42; H01M 50/42; H01M 50/434; H01M 50/443; H01M 50/446; H01M 50/449; H01M 50/489

(52) U.S. Cl. CPC H01M 10/4235; H01M 50/42; H01M 50/434; H01M 50/443; H01M 50/446; H01M 50/449; H01M 50/489

(57) ABSTRACT

Disclosed are a separator for a secondary battery and a secondary battery comprising same, the separator comprising a porous substrate, an inorganic layer positioned on at least one surface of the porous substrate, and an adhesive layer positioned on the inorganic layer, wherein the adhesive layer contains first particles and second particles which are an organic binder of different particle sizes, and the mixing volume ratio of the first particles and the second particles is 1:5 to 1:35.

### TECHNICAL FIELD

The disclosure relates to a separator for a secondary battery, and a secondary battery including the same.

### BACKGROUND ART

In order to achieve miniaturization and high performance of various devices, the miniaturization and weight reduction of lithium batteries are becoming important. In addition, for applications in the fields of electric vehicles and the like, the discharge capacity, energy density, and cycle characteristics of lithium batteries are becoming important. In order to satisfy the above applications, there is a need for a lithium battery having a high discharge capacity per unit volume, high density, excellent lifespan characteristics, and excellent safety.

In a lithium battery, a separator is disposed between a cathode and an anode to prevent a short circuit. An electrode assembly including a cathode, an anode, and a separator disposed between the cathode and the anode is wound to have the form of a jelly roll, and the jelly roll is rolled in the electrode assembly to improve the adhesion between the cathode/anode and the separator. While the interface resistance between the cathode and the separator and the interface resistance between the anode and the separator increase during such a rolling process, as the charge/discharge cycle of a lithium battery is repeated, capacity and high-rate charge/discharge characteristics may be deteriorated.

Accordingly, in order to manufacture a lithium battery with high capacity, excellent lifespan characteristics, and excellent safety, there is a need for a separator with improved adhesion and safety.

### DISCLOSURE

### Technical Problem

An aspect is to provide a separator for a secondary battery, which has improved adhesion and safety.

Another aspect is to provide a secondary battery which includes the above-described separator to has excellent capacity and lifespan characteristics and improved safety.

### Technical Solution

According to an aspect, there is provided a separator for a secondary battery, the separator including a porous substrate, an inorganic layer positioned on at least one side of the porous substrate, and an adhesive layer positioned on the inorganic layer, wherein the adhesive layer contains first particles and second particles which are organic binders with different particle sizes, and a mixing volume ratio of the first particles to the second particles is in a range of 1:5 to 1:35.

According to another aspect, there is provided a secondary battery including a cathode, an anode, and the above-described separator interposed between the cathode and the anode.

### Advantageous Effects

Since a separator for a secondary battery according to an embodiment includes an adhesive layer with improved adhesion, air permeability is good, and adhesion between the separator and an electrode is high after charging/discharging so that a shape of a battery is not deformed. Therefore, when the separator is used, a secondary battery with improved capacity, lifespan, and safety may be provided.

### DESCRIPTION OF DRAWINGS

FIG. 1 is a schematic view illustrating a cross section of a separator for a lithium battery according to an embodiment.

FIG. 2 is a schematic view illustrating a cross section of a separator for a lithium battery according to another embodiment.

FIG. 3 is a schematic view illustrating a cross section of a separator for a lithium battery according to another embodiment.

FIG. 4 is a schematic view of a lithium battery according to an embodiment.

[Description of reference numerals]

| | |
|---|---|
| 10: separator | 20: porous substrate |
| 30: inorganic layer | 40: adhesive layer |
| 140: cathode | 150: anode |
| 160: electrode assembly | 170: case |

### BEST MODE

Hereinafter, a separator for a secondary battery and a secondary battery including the same according to embodiments will be described in more detail.

In a lithium secondary battery, generally, a separator is positioned between a cathode and an anode, and a heat press process is performed at a certain temperature and pressure. Through such a hot press process, adhesion at an interface between the cathode and the separator and an interface between the anode and the separator increases to hold a shape of a battery. When adhesion is insufficient, an interface with an electrode is lifted, which becomes the fundamental cause of a continuous decrease in capacity and deterioration in high-rate charge/discharge characteristics according to a cycle of lithium polymer batteries and also lowers the safety of batteries, and thus improvement thereof is required.

Accordingly, in order to solve the above problem, the present inventors have completed a separator for a secondary battery, the separator including a porous substrate, an inorganic layer positioned on at least one side of the porous substrate, and an adhesive layer positioned on the inorganic layer, wherein the adhesive layer contains first particles and second particles which are organic binders with different particle sizes, and a volume ratio of the first particles to the second particles is in a range of 1:5 to 1:35.

In an adhesive layer according to an embodiment, two types of organic binders with different particle sizes may be used to provide a separator with improved adhesion to an inorganic layer, thereby more strongly controlling a bonding force between an electrode and a separator to manufacture a lithium secondary battery having stable cell performance without abnormal behavior such as cell expansion during charging/discharging.

A volume ratio of first particles to second particles is in a range of 1:5 to 1:35 or 1:8 to 1:30, for example, 1:20. When a volume ratio of the second particles is greater in such a range of the volume ratio of the first particles to the second particles, resistance is increased, and when the volume ratio of the second particle is smaller in such a range, a cell lifespan due to a decrease in banding strength is decreased.

The volume ratio of the first particles to the second particles is related to a diameter ratio of the first particles to the second particles, and the diameter ratio of the first particles to the second particles is, for example, in a range of 1:1.25 to 1:3.5, 1:2 to 1:3.5, 1:2.5 to 1:3.5, or 1:2.5 to 1:3.0.

According to an embodiment, the mixing weight ratio of the first particles to the second particles contained in the adhesive layer is in a range of 1:99 to 99:1, 1:90 to 90:1, 1:80 to 80:1, 70:1 to 1:70, 50:1 to 1:50, 30:1 to 1:30, 20:1 to 1:1, 10:1 to 1:1, or 5:1 to 1:1.

According to another embodiment, a mixing weight ratio of the first particles to the second particles is in range of 20:1 to 1:1, 10:1 to 1:1, 10:1 to 1.5:1, 8:1 to 1.5:1, 7:1 to 1.5:1, 6:1 to 1.5:1, 6:1 to 1.5:1, 5.5:1 to 1.5:1, 5.5:1 to 1.7:1, 5.3:1 to 1.9:1, 5.13:1 to 1.97:1, or 5:1 to 2;1. According to another embodiment, a weight ratio of the first particles to the second particles contained in the adhesive layer is in a range of 5:1 to 1:1, 4:1 to 1:1, or 3:1 to 1:1.

When the diameter ratio and weight ratio of the first particle to the second particle are in such a range, the interface resistance between a separator and an electrode may be reduced, and the separator with improved adhesion may be manufactured.

The first particles have a smaller size than the second particles.

A size of the first particles is in a range of 100 nm to 300 nm or 150 nm to 250 nm, and a size of the second particles is in a range of 500 nm to 900 nm or 500 nm to 870 nm.

As used herein, the term “size” refers to a particle diameter when particles to be measured are spherical and refers to a major axis length when particles are non-spherical. The particle diameter is, for example, an average particle diameter, and the major axis length is, for example, an average major axis length. The average particle diameter and the average major axis length refer to an average value of measured particle diameters and an average value of measured major axis lengths, respectively. In the present disclosure, a particle size refers to an average particle size.

In the present specification, a size of particles may be evaluated by using a particle size analyzer, a scanning electron microscope, or a transmission electron microscope. As the particle size analyzer, for example, an LA-950 laser particle size analyzer (manufactured by HORIBA Advanced Techno, Co., Ltd.) may be used. The average particle diameter may be, for example, an average particle diameter observed by using a scanning electron microscope (SEM) and may be calculated as an average value of particle diameters of about 10 to 30 particles by using a SEM image.

When a size of particles is measured by using a particle size analyzer, an average particle diameter refers to D50. D50 refers to an average diameter of particles corresponding to a cumulative volume of 50 vol % in a particle size distribution and refers to a value of a particle diameter corresponding to 50% from the smallest particle when the total number of particles is set to 100% in a distribution curve in which particles sizes are accumulated from the smallest particle to the largest particle.

D50 may be measured by using a particle size analyzer. Alternatively, measurement may be performed by using a measuring device using dynamic light-scattering, data analysis is performed to count the number of particles for each particle size range, and then D50 may be easily obtained therefrom through calculation.

A glass transition temperature of the first particles is not described. A thermal decomposition temperature of the first particles is 200 °C or more, 220 °C or more, or 250 °C or more, for example, in a range of 250 °C to 300 °C. When the glass transition temperature or thermal decomposition temperature of the first particles is in such a range, the first particles may serve as a filler to exhibit high heat-resistant particle characteristics.

A glass transition temperature of the second particles is in a range of 40 °C to 80 °C, 42 °C to 78 °C, 45 °C to 75 °C, 48 °C to 73 °C, or 50 °C to 70 °C. When the second particle has the above-described glass transition temperature, a bonding force between an electrode and the adhesive layer becomes stronger.

The total content of the first particles and the second particles is in a range of 60 parts by weight to 98 parts by weight, 62 parts by weight to 98 parts by weight, 63 parts by weight to 98 parts by weight, 64 parts by weight to 98 parts by weight, or for example, 65 parts by weight to 98 parts by weight with respect to 100 parts by weight of the total weight of the adhesive layer. When the total content of the first particles and the second particles is in such a range, the adhesion between an electrode and the separator is excellent.

The first and second particles are organic polymers. A weight average molecular weight of the organic polymer is in a range of 50,000 to 500,000, 100,000 to 480,000, 120,000 to 470,000, 150,000 to 450,000, 200,000 to 450,000, or for example, 300,000 to 450,000. When the weight average molecular weight of the organic polymer is in such a range, the adhesion of the separator is improved.

The first particles and the second particles may each include, for example, a butylmethacrylate-ethyleneglycol dimethacrylate copolymer, a butylmethacrylate-ethyleneglycol dimethacrylate-acrylonitrile copolymer, a styrene-ethylhexylacrylate copolymer, a styrene-ethylhexylacrylate-acrylonitrile copolymer, styrene-butadiene rubber, acrylated styrene-butadiene rubber, acrylonitrile-butadiene rubber, acrylonitrile-butadiene-styrene rubber, acrylic rubber, butyl rubber, fluoro rubber, polytetrafluoroethylene, polyethylene, polypropylene, an ethylene propylene copolymer, polyethylene oxide, polyvinylpyrrolidone, polyepichlorohydrin, polyphosphazene, polyacrylate, polyacrylonitrile, polystyrene, an ethylene propylene diene copolymer, polyvinylpyridine, chlorosulfonated polyethylene, latex, a polyester resin, an acrylic resin, a phenol resin, an epoxy resin, polyvinyl alcohol, carboxymethyl cellulose, hydroxypropyl methyl cellulose, hydroxypropyl cellulose, diacetyl cellulose, or a combination thereof.

The first particles are, for example, a polymer obtained through a polymerization reaction of a polymerizable monomer having a crosslinkable functional group, and the crosslinkable functional group is, for example, a glycidyl group, an amino group, an N-methylol group, or a vinyl group.

The polymerizable monomer having the crosslinkable functional group is hydroxy ester of ethylenic unsaturated carboxylic acid, glycidyl ester of ethylenic unsaturated carboxylic acid, glycidyl ester, amino ester of ethylenic unsaturated carboxylic acid, methylol group-containing ethylenic unsaturated amide, a monomer having two or more vinyl groups, or a combination thereof.

The hydroxy ester of ethylenic unsaturated carboxylic acid includes hydroxypropyl (meth)acrylate, hydroxyethyl (meth)acrylate, or a combination thereof, and the glycidyl ester of ethylenic unsaturated carboxylic acid includes glycidyl (meth)acrylate. The amino ester of ethylenic unsaturated carboxylic acid includes dimethylamino ethyl (meth)acrylate, the methylol group-containing ethylenic unsaturated amide includes N-methylol(meth)acrylamide, N,N-dimethylol(meth)acrylamide, or a combination thereof, and the monomer having the two or more vinyl groups includes ethylene di(meth)acrylate, divinylbenzene, or a combination thereof.

According to an embodiment, the first particles are, for example, a butylmethacrylate-ethyleneglycol dimethacrylate copolymer, a butylmethacrylate-ethyleneglycol dimethacrylate-acrylonitrile copolymer, or a combination thereof.

The second particles are, for example, a styrene-ethylhexylacrylate copolymer, a styrene-ethylhexylacrylate-acrylonitrile copolymer, or a combination thereof.

In a separator for a secondary battery according to an embodiment, the adhesive layer may further contain an additional binder such as a fluorine-based resin, a polyacrylic acid-based compound, or a combination thereof. A content of the additional binder is in a range of 1 part by weight to 3 parts by weight with respect to the total weight of the adhesive layer.

When the total content of the additional binder is in such a range, a bonding force between an electrode and the separator may be more strongly and effectively controlled.

A weight average molecular weight of the polyacrylic acid-based compound is in a range of 50,000 to 500,000, for example, 150,000 to 450,000, or for example, 300,000 to 450,000. When a weight average molecular weight of a (meth)acrylic polymer is in such a range, the adhesion of the separator is improved. In the present disclosure, a weight average molecular weight may be evaluated through gel permeation chromatography.

Examples of the polyacrylic acid-based compound may include a polyacrylic acid, a polymethylacrylic acid, a polyethylacrylic acid, a polybutylacrylic acid, a polyhexyl acrylic acid, a polyhydroxyethyl methacrylic acid, a polyaminoacrylic acid, or a combination thereof.

The fluorine-based resin serves as a binder for fixing inorganic particles onto a porous substrate and provides excellent adhesion allowing the porous substrate to be well attached to one side of the adhesive layer and allowing the electrode to be well attached to the other side of the adhesive layer. An average particle diameter of the fluorine-based resin, which is a binder, is in a range of 100 nm to 300 nm. When the fluorine-based resin has the above-described average particle diameter, the adhesion of the adhesive layer to the porous substrate is very excellent. Even when the separator is exposed to high temperature, the binder may have high heat resistance to maintain a network-structured matrix form.

The fluorine-based resin has a glass transition temperature (Tg) of 50 °C or more and a weight average molecular weight of 200,000 g/mol to 3,000,000 g/mol, 200,000 g/mol to 2,500,000 g/mol, 200,000 g/mol to 2,000,000 g/mol, 300,000 g/mol to 1,500,000 g/mol, or 300,000 g/mol to 1,200,000 g/mol. In the present specification, a weight average molecular weight may be a polystyrene-converted average molecular weight measured by using gel permeation chromatography. When the weight average molecular weight of the fluorine-based resin is in such a range, the separator may have excellent adhesion.

The fluorine-based resin is polyvinylidene fluoride, a polyvinylidene fluoride-hexafluoropropylene copolymer, a polyvinylidene fluoride-trichloroethylene copolymer, a polyvinylidene fluoride-chlorotrifluoroethylene copolymer, or a combination thereof. A (meta)acrylic binder includes polyacrylate, polymethacrylate, polybutylacrylate, polyacrylonitrile, or a combination thereof.

In the vinylidene fluoride-hexafluoropropylene copolymer, a vinylidene fluoride repeating unit may be included in a content of 90 mol % to 99.5 mol %, 93 mol % to 99 mol %, or 95 mol % to 99 mol %. When the vinylidene fluoride repeating unit is included in such a range, the vinylidene fluoride-hexafluoropropylene copolymer may secure excellent adhesion, wettability for an electrolyte, and the like.

The crystallinity of the fluorine-based resin may be in a range of 35% to 45%, for example, in a range of 38% to 45% or 40% to 45%. A separator which has adhesion and contains the fluorine-based resin having such crystallinity exhibits excellent adhesion to a substrate.

When the adhesive layer further includes a (meth)acrylic binder, a mixing weight ratio of the total weight of the first particles and the second particles to a weight of the (meth)acrylic binder may be controlled at a weight ratio of 0.01:1 to 1:1, 0.05:1 to 1:1, 0.1:1 to 1:1, 0.2:1 to 1:1, or 0.25:1 to 0.75:1.

According to another embodiment, the adhesive layer may further include, for example, at least one selected from the group consisting of polyvinylpyrrolidone, polyvinyl acetate, polyethylene oxide, cellulose acetate, cellulose acetate butyrate, cellulose acetate propionate, cyanoethylpullulan, cyanoethyl polyvinyl alcohol, cyanoethyl cellulose, cyanoethyl sucrose, pullulan, carboxylmethyl cellulose, and an acrylonitrile-styrene-butadiene copolymer.

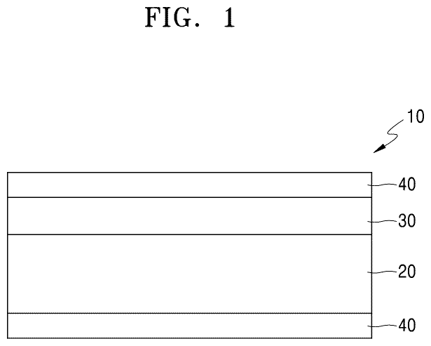

Hereinafter, a separator for a secondary battery according to an embodiment will be described in detail with reference to FIG. 1.

A secondary battery may include, for example, a lithium secondary battery.

Referring to FIG. 1, a separator 10 for a secondary battery according to an embodiment includes a porous substrate 20 and inorganic layers 30 disposed on two sides of the porous substrate 20.

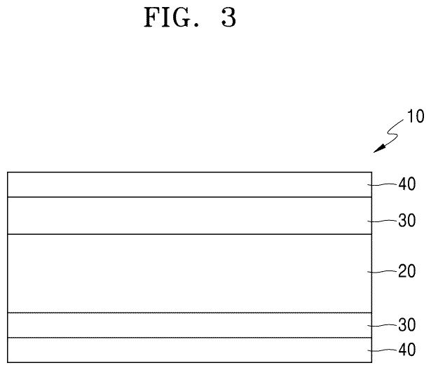

In the separator of FIG. 1, the inorganic layers 30 are positioned on two sides of the porous substrate 20, but the inorganic layer 30 may be disposed on one side of the porous substrate as shown in FIG. 3. In the separator of FIG. 3, an adhesive layer 40 is disposed on the inorganic layer 30.

The adhesive layer 40 contains first particles and second particles having different particle sizes, and a volume ratio of the first particles to the second particles is in a range of 1:8 to 1:40. By including the adhesive layer 40 described above, the separator 10 may exhibit improved heat resistance, stability, and adhesion.

The adhesive layer 40 has a thickness of 0.01 μm to 10 μm, 0.01 μm to 8 μm, 0.01 μm to 6 μm, 0.01 μm to 4 μm, or 0.04 μm to 1 μm. When the thickness of the adhesion layer is in such a range, excellent adhesion is exhibited. The thickness of the adhesive layer is measured by using a film thickness gauge. In the present disclosure, a thickness refers to an average thickness.

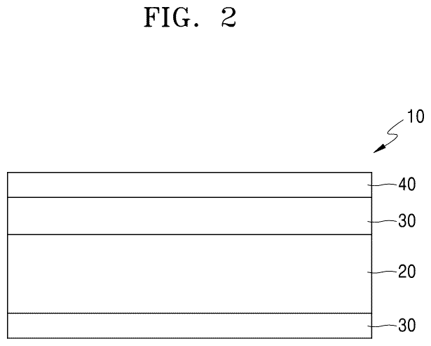

In the separator according to another embodiment, as shown in FIG. 2, the inorganic layer 30 may be further formed on the other side of the porous substrate 20. The inorganic layer 30 disposed on the other side of the porous substrate 20 may have the same or different composition as the inorganic layer 40 disposed on an upper side of the porous substrate 20.

Although not shown in the drawings, the separator according to another embodiment may have a stacked structure in which the adhesive layer 40 is disposed on the other side of the porous substrate 20.

Inorganic particles contained in the inorganic layer 40 are not particularly limited, and inorganic particles commonly used in the art may be used. Specific example of inorganic particles usable in the present disclosure may include at least one selected from Al₂O₃, SiO₂, B₂O₃, Ga₂₀₃, TiO₂, SnO₂, boehmite, BaSO₄, MgO, Mg(OH)₂, clay, ZnO, CaO, CeO₂, NiO, GaO, ZrO₂, Y₂O₃, SrTiO₃, and BaTiO₃. As the inorganic particles, the above-materials may be used alone, or a mixture of two or more thereof may be used. More specifically, Al₂O₃ (alumina) may be used as the inorganic particles.

A size of the inorganic particles is, for example, in a range of 1 μm to 20 μm, 2 μm to 15 μm, or 3 μm to 12 μm. As used herein, the term “size” refers to an average size, refers to an average particle diameter when particles are spherical, and refers to an average major axis length when particles are non-spherical. An average particle diameter refers to D50 by volume. The average particle diameter is measured by using, for example, a measuring device using a laser diffraction method or a dynamic light scattering method.

The average particle diameter is measured by using a laser scattering particle size distribution meter (for example, LA-920 manufactured by Horiba Corporation) and is a value of a median diameter (D50) when particles are accumulated to 50% from small particles in volume conversion.

When the inorganic particles having the above-described size are used, deterioration in dispersibility and coating processability of the inorganic particles in the inorganic layer may be prevented, and a thickness of the inorganic layer may be appropriately adjusted to increase mechanical properties. In addition, a size of pores generated in the separator is appropriately adjusted to reduce a possibility of an internal short circuit occurring during charging or discharging of a battery.

A content of the inorganic particles in the inorganic layer is in a range of 50 parts by weight to 95 parts by weight, 55 parts by weight to 95 parts by weight, 58 parts by weight to 95 parts by weight, 60 parts by weight to 95 parts by weight, 62 parts by weight to 95 parts by weight, 65 parts by weight to 95 parts by weight, 68 parts by weight to 95 parts by weight, 70 parts by weight to 95 parts by weight, 72 parts by weight to 95 parts by weight, or 75 parts by weight to 95 parts by weight with respect to 100 parts by weight of the total weight of the inorganic layer. When the content of the inorganic particles is such a range, the heat shrinkage of the separator may be effectively suppressed. When the inorganic particles are contained in such a range, the heat dissipation characteristics of the inorganic particles may be sufficiently exhibited, and the heat shrinkage of the separator may be effectively suppressed.

The inorganic layer 30 constituting the separator 10 is a heat-resistant layer, the shrinkage and fracture properties thereof do not deteriorate at high temperature, and the adhesion thereof to a substrate is improved.

The inorganic layer 30 has a thickness of 0.01 μm to 20 μm 0.1 μm to 20 μm, 1 μm to 20 μm, 1 μm to 15 μm, 1 μm to 13 μm, 1 μm to 10 μm, 1 μm to 8 μm, 1 μm to 6 μm, or 1 μm to 5 μm.

The inorganic layer 30 contains the inorganic particles and a binder. As the binder, a crosslinkable binder, a non-crosslinkable binder, or a combination thereof may be used.

The crosslinkable binder refers to a material that may produce a crosslinked structure binder by causing a cross-linking reaction. The crosslinkable binder may be selected from monomers, oligomers, polymers, or a mixture thereof which have at least one crosslinkable functional group. By curing the crosslinkable binder, not only physical and chemical bonds may be generated between the monomers, the oligomers, or the polymers, but also physical and chemical bonds are generated between the crosslinked and generated binder and the surface-treated inorganic particles, thereby improving adhesion to a substrate and increasing coating density to make the separator thin.

The monomer, oligomer, or polymer having at least one functional group has, for example, at least one functional group selected from the group consisting of an acrylate group, a vinyl group, a hydroxy group, an epoxy group, an oxane group, an oxetane group, a carboxyl group, an amine group, an oxazoline group, an ester group, and an isocyanate group. The functional group may be provided as two or more, three or more, or four or more functional groups.

The crosslinkable binder may include, for example, at least one acrylate selected from the group consisting of alkyl (meth)acrylate such as methyl methacrylate or methyl acrylate; bifunctional (meth)acrylate such as ethylene glycol di(meth)acrylate, propylene glycol di(meth)acrylate, polyethylene glycol di(meth)acrylate, polypropylene glycol di(meth)acrylate, di(meth)acrylate of polyoxyethylene/polyoxypropylene copolymer, butanediol di(meth)acrylate, or hexamethylene glycol di(meth)acrylate; trifunctional (meth)acrylate such as trimethylolpropane tri(meth)acrylate, glycerin tri(meth)acrylate, tri(meth)acrylate of an ethylene oxide adduct of glycerin, tri(meth)acrylate of a propylene oxide adduct of glycerin, ethylene oxide of glycerin, or tri(meth)acrylate of a propylene oxide adduct; a tetra-functional or higher multifunctional (meth)acrylate such as diglycerin hexa(meth)acrylate; multifunctional urethane acrylate; multifunctional epoxy acrylate; and polyester acrylate.

The crosslinkable binder may include, for example, vinylpyrrolidone, vinylcaprolactam, vinylimidazole, vinyl-methylacetamide, ethyl vinyl ether, propyl vinyl ether, butyl vinyl ether, pentyl vinyl ether, hexyl vinyl ether, heptyl vinyl ether, octyl vinyl ether, nonyl vinyl ether, decyl vinyl ether, cyclohexyl vinyl ether, ethylhexyl vinyl ether, dodecyl vinyl ether, octadecyl vinyl ether, or the like.

The crosslinkable binder may include, for example, biphenol, bisphenol A, methanediol, ethanediol, propanediol, butanediol, pentanediol, hexanediol, heptanediol, octanediol, nonanediol, decanediol, or the like. Examples of the monomer, the oligomer, or the polymer having at least one epoxy group may include diepoxyalkane such as diepoxyethane, diepoxypropane, diepoxybutane, diepoxypentane, diepoxyhexane, diepoxyheptane, diepoxyoctane, diepoxynonane, or diepoxydodecane; glycidyl ether such as bisphenol A diglycidyl ether, bisphenol F diglycidyl ether, brominated bisphenol A diglycidyl ether, phenol novolac glycidyl ether, or cresol novolac glycidyl ether; glycidyl ester such as hexahydrophthalic acid glycidyl ester or dimer acid glycidyl ester; alycidyl amine such as glycidyl isocyanurate or tetraglycidyl diamino phenylmethane; linear aliphatic epoxide such as epoxidized polybutadiene; and alicyclic epoxide such as 3,4-epoxy-6-methylcyclohexylmethylcarboxylate or 3,4-epoxycyclohexylmethylcarboxylate.

The crosslinkable binder may include, for example, 4,4′-diphenylene methane diisocyanate, toluene diisocyanate, tolylene diisocyanate, naphthylene diisocyanate, 4,4′dicyclohexylene methane diisocyanate, cyclohexylene diisocyanate, 3,3′dimethylphenylene diisocyanate, diphenylmethane diisocyanate, 3,3′dimethyldiphenylene methane diisocyanate, 4,6′-xylylene diisocyanate, 4,4′-dicyclohexyl mehane diisocyanate, 3,5,5-trimethylcyclohexylene diisocyanate, 1,6-hexamethylene diisocyanate, 2,2,4-trimethylhexamethylene diisocyanate, m-xylene diisocyanate, trimethylxylene diisocyanate, p-phenylene diisocyanate, isophorone diisocyanate, 1,5-naphthalene diisocyanate, trans-1,4-cyclohexyl diisocyanate, or a combination thereof.

In addition, a compound represented by Formula 1 below may be used as the crosslinkable binder.

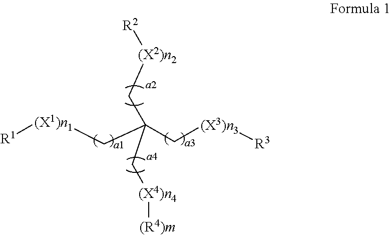

In Formula 1, X¹ to X³ are each an oxyethylene group, X⁴ is an oxyethylene group or a C1-C10 alkyl group, R¹ to R⁴ are each independently any one selected from the group consisting of a (meth)acrylate group, a hydroxyl group, a carboxyl group, an ester group, a cyanate group, an isocyanate group, an amino group, a thiol group, a C1-C10 alkoxy group, a vinyl group, and a functional group of a heterocyclic group, a¹ to a⁴ are each an integer from 1 to 10, n¹ to n³ are each an integer from 0 to 10, and at least one of n¹ to n⁴ is an integer from 1 to 10, wherein, when X⁴ is the oxyethylene group, n⁴ is an integer from 1 to 10 and m is 1, and when X⁴ is the C1-C10 alkyl group, n⁴ is 1 and m is 0.

The ester group may be represented by —COOR, the amino group may be represented by —NR^{a}R^{b}, and R, R^{a}, and R^{b} may each independently be any one selected from the group consisting of a C1-C20 alkyl group, a C2-C20 alkenyl group, a C2-C20 alkynyl group, a C3-C20 cycloalkyl group, a C3-C20 cycloalkenyl group, a C4-C20 cycloalkynyl group, and a C6-C30 aryl group. In addition, the heterocyclic group may be one selected from the group consisting of a C2-C20 heterocycloalkyl group, a C3-C20 heterocycloalkenyl group, a C3-C20 heterocycloalkynyl group, and a C6-C20 heteroaryl group and may include a heteroatom selected from N, O, and S. For example, there may be an epoxy group or an oxetane group.

The compound of Formula 1 may include, for example, a compound of Formula 2 or Formula 3 below.

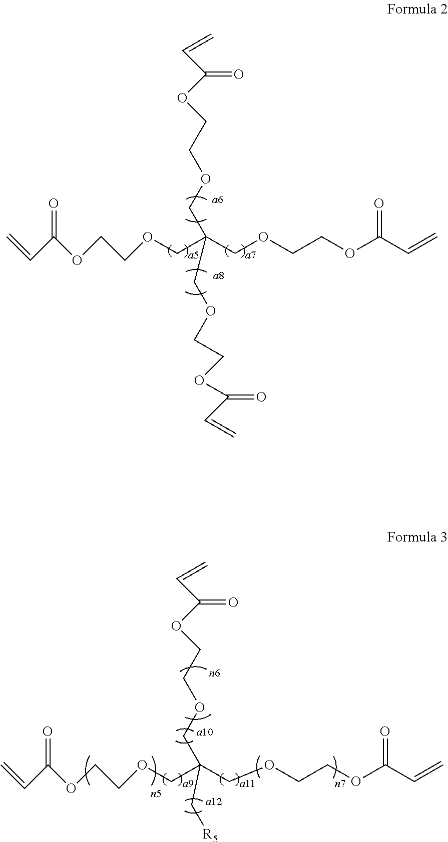

In Formula 2 and Formula 3, R⁵ may be a C1-C10 alkyl group, n⁵ to n⁷ may each be an integer from 1 to 5, and a⁵ to a¹² may each be an integer from 1 to 10.

The compound of Formula 1 may include, for example, ethoxylated pentaerythritol tetraacrylate or ethoxylated trimethylolpropane triacrylate.

A content of the crosslinkable binder is in a range of 1 part by weight to 10 parts by weight or 1 part by weights to 5 parts by weight with respect to 100 parts by weight of the total weight of the inorganic layer. In such a range, heat resistance, shrinkage, and fracture properties are excellent.

The inorganic particles contained in the inorganic layer may be surface-treated to react with the crosslinkable binder. For example, the inorganic particles may be surface-treated with a functional group that may react with the functional group of the crosslinkable binder. In the case of the surface treatment, due to a reaction between the functional group of the inorganic particles and the functional group of the crosslinkable binder, while a crosslinking reaction occurs, a crosslinking reaction between the functional groups of the inorganic particles also occurs, thereby improving a bonding force between the inorganic particles and the crosslinking binder and improving adhesion to a substrate or coating density. For example, when the crosslinkable binder has an acrylate functional group, the inorganic particles may be surface-treated to have an acrylate group.

As the crosslinkable binder contained in the inorganic layer, a binder including an aqueous crosslinking reactive acrylamide-based copolymer may be used. The aqueous crosslinking reactive acrylamide-based copolymer contains two or more crosslinking reactive groups that are crosslinkable. The aqueous crosslinking reactive acrylamide-based copolymer may be used as a one-component without a crosslinking agent, and the two or more crosslinking reactive groups may cause a crosslinking reaction with each other through a self-condensation reaction. Thus, an inorganic layer of a separator may be formed, thereby providing a separator with high heat resistance properties.

The crosslinking reactive group may include at least one first functional group selected from a carboxyl group, an amine group, and an isocyanate group; and at least one second functional group selected from a hydroxy group, an epoxy group, and an oxazoline group, and the first functional group and second functional group may be combined through a crosslinking reaction. For example, the crosslinking reactive group may include a carboxyl group and a hydroxy group.

According to an embodiment, an equivalence ratio of the first functional group to the second functional group may be in a range of 30:70 to 70:30. The equivalence ratio of the first functional group to the second functional group may be, for example, in a range of 35:65 to 65:35, 40:60 to 60:40, or 45:55 to 55:45, or example, about 50:50. In such a range, a crosslinking reaction may occur smoothly between the first functional group and the second functional group.

According to an embodiment, the acrylamide-based copolymer may include an (N-substituted) amide-based monomer, and the (N-substituted) amide-based monomer may include at least one selected from the group consisting of N,N-dialkyl(meth)acrylamide such as (meth)acrylamide, N,N-dimethyl(meth)acrylamide, N,N-diethyl(meth)acrylamide, N,N-dipropyl(meth)acrylamide, N,N-diisopropyl(meth)acrylamide, N,N-di(n-butyl)(meth)acrylamide, or N,N-di(t-butyl)(meth)acrylamide, N-ethyl(meth)acrylamide, N-isopropyl(meth)acrylamide, N-butyl(meth)acrylamide, N-n-butyl(meth)acrylamide, N-methylol(meth)acrylamide, N-ethylol(meth)acrylamide, N-methylolpropane(meth)acrylamide, N-methoxymethyl(meth)acrylamide, N-methoxyethyl(meth)acrylamide, N-butoxymethyl(meth)acrylamide, and N-acryloylmorpholine.

A content of the (N-substituted) amide-based monomer is in a range of 30 mol % to 90 mol %, 40 mol % to 80 mol %, or 50 mol % to 70 mol % with respect to the total mole of monomer components constituting the acrylamide-based copolymer. By using the acrylamide-based copolymer having the (N-substituted) amide-based monomer in such a range, decomposition temperature characteristics of 200 °C or more may be exhibited.

According to an embodiment, the acrylamide-based copolymer may include the (N-substituted) amide-based monomer; and at least one acrylic monomer selected from the group consisting of a carboxyl group-containing monomer, a (meth)acrylic acid alkyl-based monomer, a hydroxyl group-containing monomer, an isocyanate group-containing monomer, an oxazoline group-containing monomer, a hydroxyl group-containing monomer, a multifunctional (meth)acrylate-based monomer, an anhydride group-containing monomer, a sulfonic acid group-containing monomer, a phosphoric acid group-containing monomer, a succinimide-based monomer, a maleimide-based monomer, an itaconimide-based monomer, a cyano-containing monomer, a (meth)acrylic acid aminoalkyl-based monomer, a (meth)acrylic acid alkoxyalkyl-based monomer, an epoxy group-containing acrylic monomer, an acrylic acid ester-based monomer having a heterocycle, halogen atom, silicon atom, or the like, acryloylmorpholine, (meth)acrylic acid ester having an alicyclic hydrocarbon group, (meth)acrylic acid ester having an aromatic hydrocarbon group, and (meth)acrylic acid ester obtained from terpene compound derivative alcohol.

Here, two or more functional groups crosslinkable with each other may present in an (N-substituted) amide-based monomer and an acrylic monomer or may present only in the acrylic monomer.

Specific examples of the acrylic monomer may include a carboxyl group-containing monomer such as an acrylic acid, a (meth)acrylic acid, carboxyethyl acrylate, carboxypentyl acrylate, an itaconic acid, a maleic acid, a fumaric acid, a crotonic acid, or an isocrotonic acid; a (meth)acrylic acid alkyl-based monomer having a C1-C20 linear or branched alkyl in an ester portion, specifically, for example, a (meth)acrylic acid alkyl-based monomer such as methyl (meth)acrylate, ethyl (meth)acrylate, n-propyl (meth)acrylate, isopropyl (meth)acrylate, n-butyl (meth)acrylate, isobutyl (meth)acrylate, t-butyl (meth)acrylate, pentyl (meth)acrylate, isopentyl (meth)acrylate, hexyl (meth)acrylate, cyclohexyl (meth)acrylate, 2-ethylhexyl (meth)acrylate, heptyl (meth)acrylate, octyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, tridecyl (meth)acrylate, tetradecyl (meth)acrylate, pentadecyl (meth)acrylate, hexadecyl (meth)acrylate, heptadecyl (meth)acrylate, octadecyl (meth)acrylate, isooctadecyl (meth)acrylate, nonadecyl (meth)acrylate, myristyl (meth)acrylate, palmityl (meth)acrylate, stearyl (meth)acrylate, or n-tetradecyl (meth)acrylate; a hydroxyl group-containing monomer such as (meth)acrylic acid 2-hydroxyethyl, (meth)acrylic acid 2-hydroxypropyl, (meth)acrylic acid 2-hydroxybutyl, (meth)acrylic acid 3-hydroxypropyl, (meth)acrylic acid 4-hydroxybutyl, (meth)acrylic acid 6-hydroxyhexyl, (meth)acrylic acid 8-hydroxyoctyl, (meth)acrylic acid 10-hydroxydecyl, (meth)acrylic acid 12-hydroxylauryl, or (meth)acrylic acid hydroxyalkyl such as (4-hydroxymethylcyclohexyl) methyl (meth)acrylate; a multifunctional (meth)acrylate-based monomer such as hexanediol diacrylate (HDDA), tripropylene glycol diacrylate (TPGDA), ethylene glycol diacrylate (EGDA), trimethylolpropane triacrylate (TMPTA), trimethylolpropane ethoxy triacrylate (TMPEOTA), glycerin propoxylated triacrylate (GPTA), pentaerythritol tetraacrylate (PETA), or dipentaerythritol hexaacrylate (DPHA); an anhydride group-containing monomer such as maleic anhydride or itaconic anhydride; a sulfonic acid group-containing monomer such as a 2-(meth)acrylamido-2-methylpropanesulfonic acid, a (meth)acrylamidopropanesulfonic acid, a sulfopropyl (meth)acrylate, or a (meth)acryloyloxy naphthalene sulfonic acid; a phosphoric acid group-containing monomer such as [2-(2-hydroxyethyl)acryloyl]phosphate; a succinimide-based monomer such as N-(meth)acryloyl-6-oxyhexamethylene succinimide or N-(meth)acryloyl-8-oxyhexamethylene succinimide; a maleimide-based monomer such as N-cyclohexylmaleimide, N-isopropylmaleimide, N-laurylmaleimide, or N-phenylmaleimide; an itaconimide-based monomer such as N-methyl itaconimide, N-ethyl itaconimide, N-butyl itaconimide, N-octyl itaconimide, N-2-ethylhexyl itaconimide, N-cyclohexyl itaconimide, or N-lauryl itaconimide; a cyano-containing monomer such as acrylonitrile or (meth)acrylonitrile; a (meth)acrylic acid aminoalkyl-based monomer such as (meth)acrylic acid aminoethyl, (meth)acrylic acid N,N-dimethylaminoethyl, (meth)acrylic acid N,N-dimethylaminoethyl, or (meth)acrylic acid t-butylaminoethyl; a (meth)acrylic acid alkoxyalkyl-based monomer such as (meth)acrylic acid methoxyethyl, (meth)acrylic acid ethoxyethyl, (meth)acrylic acid propoxyethyl, (meth)acrylic acid butoxyethyl, or (meth)acrylic acid ethoxypropyl; an epoxy group-containing acrylic monomer such as (meth)acrylic acid glycidyl; an acrylic acid ester-based monomer having a heterocycle, halogen atom, silicon atom, or the like such as (meth)acrylic acid tetrahydrofurfuryl, fluorine atom-containing (meth)acrylate, or silicone (meth)acrylate; acryloylmorpholine; (meth)acrylic acid ester having an alicyclic hydrocarbon group such as cyclopentyl (meth)acrylate, cyclohexyl (meth)acrylate, isobornyl (meth)acrylate, or dicyclopentanyl (meth)acrylate; (meth)acrylic acid ester having an aromatic hydrocarbon group such as phenyl (meth)acrylate or phenoxyethyl (meth)acrylate; and (meth)acrylic acid ester obtained from terpene compound derivative alcohol. As the acrylamide-based copolymer, the above-described acrylic monomers may be used alone, or a combination of two or more thereof may be used.

According to an embodiment, a molar ratio of the (N-substituted) amide-based monomer to the acrylic monomer may be in a range of 1:99 to 99:1, 20:80 to 80:20, 30:70 to 70:30, or 40:60 to 60:40 or may be 50:50. In such a range, a coating layer of a separator with improved heat resistance may be formed.

A weight average molecular weight of the acrylamide-based copolymer is in a range of 100,000 g/mol to 1 million g/mol, 150,000 g/mol to 800,000 g/mol, 180,000 g/mol to 750,000 g/mol, 200,000 g/mol to 700,000 g/mol, 250,000 g/mol to 650,000 g/mol, or 300,000 g/mol to 600,000 g/mol. By using the acrylamide-based copolymer having a weight average molecular weight in such a range, a separator having a low shrinkage rate when stored at high temperature may be prepared.

A glass transition temperature of the acrylamide-based copolymer may be 150 °C or more or in a range of 150 °C to 300 °C, 170 °C to 280 °C, or 190 °C to 250 °C. By using the acrylamide-based copolymer having a glass transition temperature in such a range, an inorganic layer of a separator with high heat resistance may be formed.

The acrylamide-based copolymer may include, for example, an acrylic acid-acrylamide-(2-acrylamido)-(2-methylpropanesulfonic acid) copolymer, an aqueous crosslinking reactive polyacrylamide-acrylic acid-hydroxyethylacrylic copolymer, or a combination thereof.

According to an embodiment, the acrylamide-based copolymer may further include at least one non-acrylic monomer. Since the acrylamide-based copolymer further includes at least one non-acrylic monomer, the heat resistance of a copolymer and the adhesion strength of a separator to a porous substrate may be further improved.

A non-acrylic monomer may be used without particular limitation as long as the non-acrylic monomer is not the above-described acrylic monomer and is a copolymerizable monomer. A copolymerizable non-acrylic monomer may be, for example, vinyl ester, a nitrogen-containing heterocyclic monomer, N-vinylcarboxylic acid amide, a lactam-based monomer, an olefin-based monomer, a vinyl ether-based monomer, an aromatic vinyl compound, olefin or diene, vinyl ether, vinyl chloride, a sulfonic acid group-containing monomer, an imide group-containing monomer, or an isocyanate group-containing monomer and may include at least one selected therefrom.

Specific examples of the non-acrylic monomer may include vinyl esters such as vinyl acetate and vinyl propionate; nitrogen-containing heterocyclic monomers such as N-vinyl-2-pyrrolidone, N-methylvinylpyrrolidone, N-vinylpyridine, N-vinylpiperidone, N-vinylpyrimidine, N-vinylpiperazine, N-vinylpyrazine, N-vinylpyrrole, N-vinylimidazole, N-vinyloxazole, N-(meth)acryloyl-2-pyrrolidone, N-(meth)acryloyl piperidine, N-(meth)acryloyl pyrrolidine, N-vinylmorpholine, N-vinyl-2-piperidone, N-vinyl-3-morpholinone, N-vinyl2-caprolactam, N-vinyl-1,3-oxazin-2-one, N-vinyl-3,5-morpholinedione, N-vinylpyrazole, N-vinylisoxazole, N-vinylthiazole, N-vinylisothiazole, and N-vinylpyridazine; N-vinylcarboxylic acid amides; lactam monomers such as N-vinylcaprolactam; olefin-based monomers such as isoprene, butadiene, and isobutylene; vinyl ether-based monomers such as methyl vinyl ether and ethyl vinyl ether; aromatic vinyl compounds such as vinyltoluene and styrene; olefins or dienes such as ethylene, butadiene, isoprene, and isobutylene; vinyl ethers such as vinyl alkyl ether; vinyl chloride; sulfonic acid group-containing monomers such as vinyl chloride, a styrene sulfonic acid, an allyl sulfonic acid, and sodium vinyl sulfonate; imide group-containing monomers such as cyclohexylmaleimide and isopropylmaleimide; and isocyanate group-containing monomers such as 2-isocyanate ethyl (meth)acrylate. The non-acrylic monomers may be used alone or in combination of two or more.

A content of the non-acrylic monomer included in the acrylamide-based copolymer is not particularly limited in a range that does not impair the aqueous crosslinking reaction characteristics of the acrylamide-based copolymer and the high heat resistance characteristics of the separator. For example, the non-acrylic monomer may be included in a range of 0.1 mol % to 30 mol % with respect to the total mole of the monomer components constituting the acrylamide-based copolymer.

The content of the acrylamide-based copolymer may be in a range of 10 wt % to 100 wt %, 30 wt % to 95%, 50 wt % to 90 wt %, or 60 wt % to 80 wt % with respect to the total weight of the binder. In such a range, a composition for forming an inorganic layer of a separator with improved heat resistance and adhesion to a substrate may be provided.

The inorganic layer may further include a non-crosslinkable binder. Since the inorganic layer additionally includes the non-crosslinkable binder, adhesion to a substrate or electrode and heat resistance may be further improved.

The non-crosslinkable binder may include, for example, at least one selected from the group consisting of a polyvinylidene fluoride (PVDF)-based polymer, polymethyl methacrylate, polyacrylonitrile, polyvinylpyrrolidone, polyvinyl acetate, polyethylene oxide, cellulose acetate, cellulose acetate butyrate, cellulose acetate propionate, cyanoethyl pullulan, cyanoethyl polyvinyl alcohol, cyanoethyl cellulose, cyanoethyl sucrose, pullulan, carboxymethyl cellulose, and an acrylonitrile-butadiene-styrene copolymer, or a mixture thereof. The non-crosslinkable binder may include, for example, a vinylidene fluoride-based polymer.

The vinylidene fluoride-based polymer may be, for example, PVDF, a vinylidene fluoride copolymer, or a mixture thereof. The vinylidene fluoride copolymer refers to a polymer including repeating unit in a content of 5 wt % or less in addition to a vinylidene fluoride repeating unit. The vinylidene fluoride copolymer may include, for example, a vinylidene fluoride-hexafluoropropylene copolymer.

When the non-crosslinkable binder is included in addition to the crosslinked structure binder, a weight ratio of the crosslinked structure binder to the non-crosslinkable binder may be in a range of 8:2 to 2:8, specifically 3:7 to 7:3. When the non-crosslinkable binder is used in such a range, a separator with improved adhesion and heat resistance may be prepared.

A thickness of the porous substrate is, for example, in a range of 1 μm to 100 μm, 1 μm to 40 μm, 1 μm to 30 μm, 5 μm to 20 μm, 5 μm to 15 μm, or 5 μm to 10 μm. In the present disclosure, a thickness refers to an average thickness. When the porous substrate having a thickness in such a range is used, a separator, which has an appropriate thickness, which is thick enough to prevent a short circuit between a cathode and an anode of a battery but is not thick enough to increase the internal resistance of the battery, may be prepared.

The porous substrate included in the separator may have a porosity of 5% to 95% or 30% to 80%, for example, 40% to 60%, and an air permeability of 250 sec/100 cc or less, 230 sec/100 cc or less, 210 sec/100 cc, 200 sec/100 cc or less, 180 sec/100 cc or less, or 150 sec/100 cc or less. A pore size of the porous substrate in the separator may be in a range of 0.01 μm to 50 μm, 0.01 μm to 30 μm, 0.01 μm to 20 μm, or 0.01 μm to 10 μm. In the present disclosure, a pore size refers to an average pore size. When the porosity, air permeability, and pore size of the porous substrate including the separator are in such a range, the porous substrate with excellent mechanical properties may be obtained without an increase in internal resistance of a lithium battery.

In a nonrestrictive example, the porous substrate may be a polymer film formed of any one polymer or a mixture of two or more selected from the group consisting of polyolefin such as polyethylene or polypropylene, polyester such as polyethylene terephthalate or polybutylene terephthalate, polyacetal, polyamide, polyimide, polycarbonate, polyetheretherketone, polyaryletherketone, polyetherimide, polyamideimide, polybenzimidazole, polyethersulfone, polyphenylene oxide, a cyclic olefin copolymer, polyphenylene sulfide, and polyethylene naphthalate.

In an example, the porous substrate may be a polyolefin-based substrate, and the polyolefin-based substrate may have an excellent shut down function, which may contribute to improving the safety of a battery. The polyolefin-based substrate may be selected from the group consisting of, for example, a polyethylene single film, a polypropylene single film, a polyethylene/polypropylene double film, a polypropylene/polyethylene/polypropylene triple film, and a polyethylene/polypropylene/polyethylene triple film. In another example, the polyolefin-based resin may include a non-olefin resin in addition to an olefin resin or may include a copolymer of olefin and a non-olefin monomer.

Any method of preparing a separator according to an embodiment may be used as long as the method may be used in the art. For example, the separator may be prepared according to a process in which a slurry including inorganic particles, a first binder, and optionally inorganic particles is prepared, applied onto a porous substrate, and then dried and rolled.

A method of applying the slurry is not particularly limited, and any method may be used as long as the method may be used in the art. For example, the separator may be prepared through a method including, for example, printing, compression, intrusion, roller coating, blade coating, brush coating, dip coating, spray coating, or cast coating.

Before a porous adhesive layer is formed on one side or two sides of a separator substrate, in order to improve adhesiveness to the adhesive layer, pretreatment such as sulfonation treatment, graft treatment, corona discharge treatment, ultraviolet irradiation treatment, plasma treatment, or spatter etching treatment may be optionally performed.

In a separator for a secondary battery according to an embodiment, adhesion to the porous substrate may be 0.5 N/mm or more, 0.7 N/mm or more, 0.8 N/mm or more, or specifically in a range of 0.8 N/mm to 0.99 N/mm, for example, 0.81 N/mm to 0.93 N/mm. When adhesion to a substrate is in such a range, the adhesion between the adhesive layer and the porous substrate may be excellent, and thus the performance of a battery may be maintained for a long period of time. A method of measuring the adhesion to the substrate is not particularly limited, and a method commonly used in the art of the present disclosure may be used.

A non-limiting example of a method of measuring the adhesion of the separator to the substrate is as follows: according to Korean Industrial Standard KS-A-01107 (Testing Method for Adhesive Tapes and Adhesive Sheets), a separator is cut to 25 mm in width and 250 mm in length, tape (Nitto 31B) is attached to each of two sides to prepare a specimen, and the specimen is pressed by reciprocating once at a speed of 300 mm/min using a pressing roller with a load of 2 kg. After 30 minutes of pressing, the specimen is turned over 180°, about 25 mm of the specimen is peeled off, and then the separator and the tape attached to one side of the separator are fixed to an upper clip of a tensile tester (Instron Series 1X/s Automated materials Tester-3343 manufactured by Instron). The tape attached to the other side of the separator is fixed to a lower clip and then pulled at a tensile speed of 60 mm/min to measure pressure when a porous adhesive layer is peeled off of a porous substrate, thereby obtaining the adhesion to the substrate.

The adhesion of the separator to a cathode may be 0.5 gf/5 mm or more, and the adhesion of the separator to an anode may be 0.1 gf/5 mm or more. Specifically, the adhesion of the separator to the cathode may be 0.8 gf/5 mm or more, and the adhesion of the separator to the anode may be 0.2 gf/5 mm or more. Since the separator is sufficiently attached to a cathode and an anode in such a range, in an environment in which the expansion and contraction of a battery are repeated as the charging/discharging of the battery including the separator is repeated, a change in shape of the battery may be minimized, and a short ion transfer distance may be secured to improve the output efficiency of the battery.

According to another embodiment of the present disclosure, there is provided as a secondary battery including a cathode, an anode, a separator according to an embodiment positioned between the cathode and the anode, and an electrolyte.

The secondary battery may be, for example, a lithium secondary battery such as a lithium metal secondary battery, a lithium ion secondary battery, a lithium polymer secondary battery, or a lithium ion polymer secondary battery.

A method of manufacturing the secondary battery according to an embodiment is not particularly limited, and a method commonly used in the art of the present disclosure may be used.

Hereinafter, a method of preparing a separator according to an embodiment will be described.

An inorganic layer is provided on a porous substrate. When the inorganic layer is formed, a coating method, lamination, coextrusion, or the like may be used. Non-limiting examples of the coating method may include roll coating, spin coating, dip coating, flow coating, and spray coating, but one or more embodiments are not necessarily limited thereto.

The inorganic layer may be cured by providing a composition for forming an inorganic layer on the porous substrate and then applying light or heat thereto. Specifically, photocuring may be ultraviolet curing or far-infrared curing, for example, ultraviolet curing. The photocuring may include, for example, irradiating a light amount of 500 mJ/cm² to 3,000 mJ/cm², specifically 500 mJ/cm² to 2,000 mJ/cm² onto a porous heat-resistant layer. An irradiation time may be in a range of 1 minute to 15 hours. After the photocuring, homogeneous curing density may be obtained through subsequent heat treatment, and the subsequent heat treatment may be performed for 1 hour to 10 hours at a temperature of about 50 °C to about 180 °C. In addition, thermal curing may include performing curing at a temperature about 40 °C to about 120 °C, about 50 °C to about 100 °C, or about 60 °C to about 90 °C for 1 hour to 36 hours, specifically, for about 5 hours to about 24 hours.

The composition for forming the inorganic layer may include a material for forming the crosslinking binder and/or a polymerization initiator for crosslinking the crosslinking binder and surface-treated inorganic particles.

The polymerization initiator may serve as a curing agent that generates free radicals through heating or light and may be appropriately selected according to types of materials for generating the crosslinked structure binder and functional groups of inorganic particles. For example, an initiator may include a peroxide-based, azo-based, amine-based, imidazole-based, or isocyanate-based thermal polymerization initiator or a photopolymerization initiator such as an onium salt or an organic metal salt.

Next, an adhesive layer composition, which contains first particles and second particles, which are organic binders, and a solvent, is applied onto the inorganic layer and dried to form an adhesive layer.

The adhesive layer composition may be provided in the form of a slurry by including waster as the solvent. A composition for forming a first coating layer may further include an organic solvent as long as aqueous characteristics are not impaired. The organic solvent may be an alcohol-based organic solvent. For example, the organic solvent may include at least one alcohol-based organic solvent selected from the group consisting of methanol, ethanol, propanol, and butanol. By using the alcohol-based organic solvent, the composition for forming the first coating layer, which is harmless to the body and has excellent drying characteristics to secure mass production without a reduction in productivity, may be provided. According to an embodiment, water and the organic solvent may be included in a volume ratio of 100:0 to 60:40, 95:5 to 80:20, or 85:15 to 70:30. In such a range, a composition for forming a first coating layer of a separator, which has improved drying characteristics, may be provided.

After the applying of the composition for forming the first coating layer of the separator, the solvent is volatilized through drying and thus is not present in a coating layer of the finally obtained separator.

The coating method is not particularly limited. For example, at least one may be selected from a forward roll coating method, a reverse roll coating method, a microgravure coating method, and a direct metering coating method, but one or more embodiments are not necessarily limited to such a method. The coating method may be, for example, a direct metering coating method.

The drying may be performed by using hot air in a dryer. The drying may be performed, for example, at a temperature of 30 °C to 80 °C, 35 °C to 75 °C, 40 °C to 70 °C, or 45 °C to 65 °C. By performing drying in such a temperature range, a separator of which both bending strength and peel strength are improved may be prepared.

A secondary battery according to another embodiment includes a cathode, an anode, and the above-described separator disposed between the cathode and the anode. The secondary battery is, for example, a lithium secondary battery.

According to an embodiment, a secondary battery may include an electrode assembly including a cathode, an anode, and the above-described separator disposed between the cathode and the anode, and the electrode assembly may be wound in the form of a jelly roll. The lithium battery may include the above-described separator, and thus adhesion between electrodes (cathode and anode) and the separator may increase, thereby suppressing a change in volume during charging/discharging of the lithium battery. Therefore, the deterioration of the lithium battery due to a change in volume of the lithium secondary battery may be suppressed, thereby improving the lifespan characteristics of the lithium battery.

The lithium secondary battery may be manufactured, for example, through the following method.

First, an anode active material composition in which an anode active material, a conductive material, a binder, and a solvent are mixed is prepared. The anode active material composition is applied directly onto a metal current collector to prepare an anode plate. Alternatively, the anode active material composition may be cast on a separate support, and then a film peeled off of the support may be laminated on a metal current collector to prepare the anode plate. The anode is not limited to the forms listed above and may have forms other than the above forms.

The anode active material includes a carbon-based material.

The carbon-based material may be crystalline carbon, amorphous carbon, or a mixture thereof. The crystalline carbon may be non-shaped carbon, plate-shaped carbon, flake-shaped carbon, natural graphite, artificial graphite, graphene, carbon black, fullerene soot, or a combination thereof.

Natural graphite is graphite that occurs naturally and includes flake graphite, high crystalline graphite, microcrystalline or cryptocrystalline (amorphous) graphite, and the like. Artificial graphite is artificially synthesized graphite and made by heating non-shaped carbon to high temperature and includes primary or electrographite, secondary graphite, graphite fiber, and the like. Expanded graphite is a graphite obtained by intercalating chemicals such as acid or alkali between graphite layers and heating the resulting graphite to inflate a vertical layer of a molecular structure. Graphene includes a single layer of graphite or a plurality of single layers. Carbon black is a crystalline material with less regularity than graphite, and when the carbon black is heated at a temperature of about 3,000 °C for a long period of time, the carbon black may turn into graphite. Fullerene soot refers to a carbon mixture including fullerene in a content of at least 3 wt %, wherein the fullerene is a polyhedral bundle-shaped compound consisting of 60 or more carbon atoms. The crystalline carbon may have a spherical, plate-shaped, fibrous, tubular, or powder form.

The amorphous carbon may be soft carbon (low-temperature calcined carbon), hard carbon, mesophase pitch carbide, calcined coke, polymer carbide, or a combination thereof.

The anode active material may further include a non-carbon-based material. For example, the anode active material may include at least one selected from the group consisting of a metal capable of forming an alloy with lithium, an alloy of a metal capable of forming an alloy with lithium, and an oxide of a metal capable of forming an alloy with lithium.

Examples of a metal alloyable with the lithium may include Si, Sn, Al, Ge, Pb, Bi, Sb, a Si—Y alloy, wherein Y is an alkali metal, an alkali earth metal, Groups 13 to 16 elements, a transition metal, a rare earth element, or a combination thereof and is not Si), a Sn—Y alloy, wherein Y is an alkali metal, an alkali earth metal, Groups 13 to 16 elements, a transition metal, a rare earth element, or a combination thereof and is not Sn, and the like. The element Y may include Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ge, P, As, Sb, Bi, S, Se, Te, Po, or a combination thereof.

For example, the transition metal oxide may be lithium titanium oxide, vanadium oxide, lithium vanadium oxide, or the like.

For example, the non-transition metal oxide may be SnO₂, SiOₓ, wherein 0<x<2, or the like.

Specifically, the anode active material may include at least one selected from the group consisting of Si, Sn, Pb, Ge, Al, SiOₓ, wherein 0<x≤2, SnO_{y}, wherein 0<y≤2, Li₄Ti₅O₁₂, TiO₂, LiTiO₃, and Li₂Ti₃O₇, but one or more embodiments are not necessarily limited thereto. Any material may be used as long as the material is a non-carbon-based anode active material and is used in the art.

According to an embodiment, the anode active material may include be a mixture of the above-described carbon-based material and non-carbon-based material or a composite containing the above-described carbon-based material and non-carbon-based material. The conductive material may include acetylene black, Ketjen black, natural graphite, artificial graphite, carbon black, carbon fiber, a metal powder of copper, nickel, aluminum, silver, or the like, metal fiber, or the like and may also include at least one or a mixture of one or more selected from conductive materials such as polyphenylene derivatives, but one or more embodiments are not limited thereto. Any material may be used as long as the material may be used as a conductive material in the art. In addition, the above-described crystalline carbon-based material may be added as the conductive material.

The binder may include at least one selected from a vinylidene fluoride/hexafluoropropylene copolymer, PVDF, polyacrylonitrile, polymethyl methacrylate, polytetrafluoroethylene, a styrene butadiene rubber-based polymer, or a mixture thereof, but one or embodiments are not limited thereto. Any material may be used as long as the material may be used as a binder in the art.

The solvent may include N-methylpyrrolidone, acetone, or water, but one or more embodiments are not limited thereto. Any solvent usable in the art may be used.

Contents of the anode active material, the conductive material, the binder, and the solvent are at a level commonly used in a lithium battery. According to the use and configuration of a lithium battery, at least one of the conductive material, the binder, and the solvent may be omitted.

Meanwhile, the binder used to prepare the anode may be the same as a coating composition included in the adhesive layer of the separator.

Next, a cathode active material composition in which a cathode active material, a conductive material, a binder, and a solvent are mixed is prepared. The cathode active material composition is applied directly onto a cathode current collector and dried to prepare a cathode plate. Alternatively, the cathode active material composition may be cast on a separate support, and then a film peeled off of the support may be laminated on a metal current collector to prepare the cathode.

The cathode active material may further include at least one selected from the group consisting of lithium cobalt oxide, lithium nickel cobalt manganese oxide, lithium nickel cobalt aluminum oxide, lithium iron phosphate oxide, and lithium manganese oxide, but one or more embodiments are not necessarily limited thereto. Any cathode active material usable in the art may be used.

For example, the cathode active material may include a compound represented by any one of formulas of LiₐA_{1-b}B_{b}D₂, wherein 0.90≤a≤1.8 and 0≤b≤0.5; LiₐE_{1-b}B_{b}O_{2-c}D_{c}, wherein 0.90≤a≤1.8, 0≤b≤0.5, and 0≤c≤0.05; LiE_{2-b}B_{b}O_{4-c}D_{c}; wherein 0≤b≤0.5 and 0≤c≤0.05; LiₐNi_{1-b-c}Co_{b}B_{c}D_{α}, wherein 0.90≤a≤1.8, 0≤b≤0.5, 0≤c≤0.05, and 0<α≤2; LiₐNi_{1-b-c}Co_{b}B_{c}O_{2-α}F_{α}, wherein 0.90≤a≤1.8, 0≤b≤0.5, 0≤c≤0.05, and 0<α<2; LiₐNi_{1-b-c}Co_{b}B_{c}O_{2-α}F₂, wherein 0.90≤a≤1.8, 0≤b≤0.5, 0≤c≤0.05, and 0<α<2; LiₐNi_{1-b-c}Mn_{b}B_{c}D_{α}, wherein 0.90≤a≤1.8, 0≤b≤0.5, 0≤c≤0.05, and 0<α≤2; LiₐNi_{1-b-c}Mn_{b}B_{c}O_{2-α}F_{α}, wherein 0.90≤a≤1.8, 0≤b≤0.5, 0≤c≤0.05, and 0<α<2; LiₐNi_{1-b-c}Mn_{b}B_{c}O_{2-α}F₂, wherein 0.90≤a≤1.8, 0≤b≤0.5, 0≤c≤0.05, and 0<α<2; LiₐNi_{b}E_{c}G_{d}O₂, wherein 0.90≤a≤1.8, 0≤b≤0.9, 0≤c≤0.5, and 0.001≤d≤0.1; LiₐNi_{b}Co_{c}Mn_{d}GₑO₂, wherein 0.90≤a≤1.8, 0≤b≤0.9, 0≤c≤0.5, 0≤d≤0.5, and 0.001≤e≤0.1; LiₐNiG_{b}O₂, wherein 0.90≤a≤1.8 and 0.001≤b≤0.1; LiₐCoG_{b}O₂, wherein 0.90≤a≤1.8 and 0.001≤b≤0.1; LiₐMnG_{b}O₂, wherein 0.90≤a≤1.8 and 0.001≤b≤0.1; LiₐMn₂G_{b}O₄, wherein 0.90≤a≤1.8 and 0.001≤b≤0.1; QO₂; QS₂; LiQS₂; V₂O₅; LiV₂O₅; LiIO₂; LiNiVO₄; Li_{(3-f)}J₂(PO₄)₃, wherein 0≤f≤2; Li_{(3-f)}Fe₂(PO₄)₃, wherein 0≤f≤2; and LiFePO₄.

In the above formulas, A is Ni, Co, Mn, or a combination thereof; B is Al, Ni, Co, Mn, Cr, Fe, Mg, Sr, V, a rare earth element, or a combination thereof; D is O, F, S, P, or a combination thereof; E is Co, Mn, or a combination thereof; F is F, S, P, or a combination thereof; G is Al, Cr, Mn, Fe, Mg, La, Ce, Sr, V, or a combination thereof; Q is Ti, Mo, Mn, or a combination thereof; I is Cr, V, Fe, Sc, Y, or a combination thereof; and J is V, Cr, Mn, Co, Ni, Cu, or a combination thereof.

Of course, the cathode active material including a coating layer on a surface of the compound may be used, or a mixture of the above-described compound and a compound having a coating layer may be used. The coating layer may include, for example, a coating element compound of an oxide or hydroxide of a coating element, an oxyhydroxide of the coating element, an oxycarbonate of the coating element, or a hydroxycarbonate of the coating element. A compound constituting the coating layer is amorphous or crystalline. The coating element included in the coating layer may include Mg, Al, Co, K, Na, Ca, Si, Ti, V, Sn, Ge, Ga, B, As, Zr, or a mixture thereof. In a process of forming the coating layer, any coating method may be used as long as the compound may be coated with such elements through a method (for example, a spray coating method or a dipping method) that does not adversely affect physical properties of the cathode active material. Since the coating method is known well to those who work in the related field, a detailed description thereof will be omitted.

For example, LiNiO₂, LiCoO₂, LiMnₓO₂ₓ, wherein x is 1 or 2, LiNi₁₋ₓMnₓO₂, wherein 0<x<1, LiNi_{1-x-y}CoₓMn_{y}O₂, wherein 0≤x≤0.5 and 0≤y≤0.5, LiFeO₂, V₂O₅, TiS, MoS, or the like may be used.

The conductive material, the binder, and the solvent of the cathode active material composition may be the same as those of the anode active material composition. Meanwhile, a plasticizer may also be further added to the cathode active material composition and/or the anode active material composition to form pores in an electrode plate.

Contents of the cathode active material, the conductive material, the general binder, and the solvent are at a level commonly used in a lithium battery. According to the use and configuration of a lithium battery, at least one of the conductive material, the general binder, and the solvent may be omitted.

Meanwhile, the binder used to prepare a cathode may be the same as a composition included in the adhesive layer of the separator.

Next, the above-described separator is disposed between the cathode and the anode.

In an electrode assembly including a cathode/separator/anode, as described above, the separator disposed between the cathode and the anode includes a porous substrate, and adhesive layers disposed on two sides of the porous substrate, wherein the adhesive layer includes the above-described coating composition for a separator.

The separator may be prepared separately and disposed between the cathode and the anode. Alternatively, the separator may be prepared by winding an electrode assembly including a cathode/separator/anode in the form of a jelly roll to then accommodate the jelly roll in a battery case or pouch, thermally softening the jelly roll under pressure in a state in which the jelly roll is accommodated in the battery case or pouch, pre-charging the jelly roll, hot-rolling the charged jelly roll, cold-rolling the charged jelly roll, and performing a formation operation of charging/discharging the charged jelly roll under pressure.

Next, an electrolyte is prepared.

The electrolyte may be in a liquid or gel state.

For example, the electrolyte may be an organic electrolyte. In addition, the electrolyte may be a solid. The electrolyte may include, for example, boron oxide, lithium oxynitride, or the like, but one or more embodiments are not limited thereto. Any material may be used as long as the material may be used a solid electrolyte in the art. The solid electrolyte may be formed on the anode through a method including sputtering.

For example, an organic electrolyte may be prepared. The organic electrolyte may be prepared by dissolving a lithium salt in an organic solvent.

As the organic solvent, any material may be used as long as the material may be used as an organic solvent in the art. Examples of the organic solvent may include propylenecarbonate, ethylenecarbonate, fluoroethylenecarbonate, butylenecarbonate, dimethylcarbonate, diethylcarbonate, methylethylcarbonate, methylpropylcarbonate, ethylpropylcarbonate, methylisopropylcarbonate, dipropylcarbonate, dibutylcarbonate, methylpropionate, ethylpropionate, propylpropionate, benzonitrile, acetonitrile, tetrahydrofurane, 2-methyltetrahydrofurane, γ-butyrolactone, dioxirane, 4-methyldioxirane, N,N-dimethylformamide, dimethylacetamide, dimethylsulfoxide, dioxane, 1,2-dimethoxyethane, sulfolane, dichloroethane, chlorobenzene, nitrobenzene, diethyleneglycol, dimethylether, or a mixture thereof.

As the lithium salt, any material may be used as long as the material may be used as a lithium salt in the art. Examples of the lithium salt may include LiPF₆, LiBF₄, LiSbF₆, LiAsF₆, LiClO₄, LiCF₃SO₃, Li(CF₃SO₂)₂N, Li(FSO₂)₂N, LiC₄F₉SO₃, LiAlO₂, LiAlCl₄, LiN(CₓF₂ₓ₊₁SO₂)(C_{y}F_{2y+1}SO₂), wherein x and y are each a natural number, LiCl, LiI, or a mixture thereof.

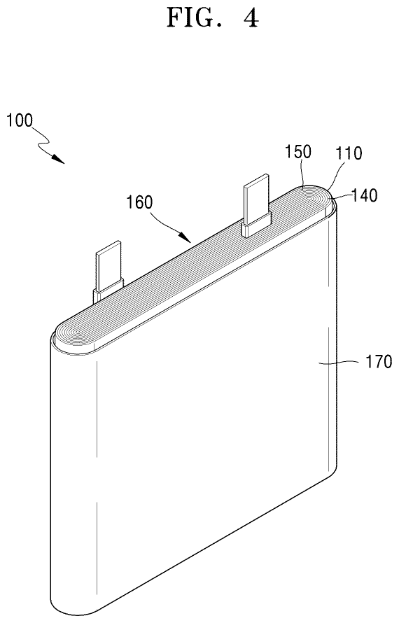

As an example of a secondary battery, a prismatic lithium secondary battery will be described. FIG. 4 is an exploded perspective view of a lithium battery according to an embodiment.

Referring to FIG. 4, a lithium secondary battery 100 according to an embodiment includes an electrode assembly 160 in which a separator 110 according to an embodiment is interposed between a cathode 140 and an anode 150 and wound, and a case 170 in which the electrode assembly 160 is embedded.

The electrode assembly 160 may be, for example, in the form of a jelly roll formed by winding the cathode 140 and the anode 150 with the separator 110 interposed therebetween.

The cathode 140, the anode 50, and the separator 110 are impregnated with an electrolyte (not shown).

The lithium secondary battery may be a lithium ion battery. The lithium battery may be a lithium polymer battery.

The lithium battery has excellent high-rate characteristics and lifespan characteristics and thus is suitable for electric vehicles (EVs). For example, the lithium battery is suitable for hybrid vehicles such as plug-in hybrid electric vehicles (PHEVs).

Hereinafter, the present disclosure will be described in more detail with reference to the following Examples and Comparative Examples. However, Examples are for illustrative purposes only and are not intended to limit the scope of the disclosure.

### Preparation Example 1: Preparation of Acrylic Copolymer

Distilled water (6,361 g), acrylic acid (72.06 g, 1.0 mol), acrylamide (604.1 g, 8.5 mol), potassium persulfate (2.7 g, 0.01 mol), 2-acrylamido-2-methylpropanesulfonic acid (103.6 g, 0.5 mol), and a 5 N lithium hydroxide aqueous solution (1.05 equivalent with respect to a total amount of a 2-acrylamido-2-methylpropanesulfonic acid) were put into a 10 L four-necked flask equipped with a stirrer, a thermometer, and a cooling tube. Then, an operation of reducing the internal pressure to 10 mmHg with a diaphragm pump and returning the internal pressure to a normal pressure with nitrogen was repeated three times.

A reaction solution was allowed to react for 12 hours while a temperature of the reaction solution was controlled to be stable between 65 °C and 70 °C. After the reaction solution was cooled to room temperature, a pH of the reaction solution was adjusted to a range of 7 to 8 by using a 25% aqueous ammonia solution. In this way, poly(acrylic acid-co-acrylamide-co-2-acrylamido-2-methylpropanesulfonic acid), which is an acrylic copolymer, was prepared. A molar ratio of the acrylic acid, the acrylamide, and the 2-acrylamido-2-methylpropanesulfonic acid is 10:85:5. About 10 mL of the reaction solution (reaction product) was taken to measure a non-volatile component, and a result was 9.5 wt % (theoretical value: 10 wt %).

### Preparation of Separator

### Example 1: Separator Having Stacked Structure of Adhesive Laver/Inorganic Layer/Porous Substrate/Inorganic Layer/Adhesive Layer

First, boehmite (manufactured by Nabaltec, Germay) with an average size of 300 nm was pulverized for 2 hours by using a bead mill, and then 40 wt % of an inorganic dispersion of the pulverized boehmite was obtained. In the inorganic dispersion, the amount of water was 70 wt %. Here, the acrylic copolymer prepared according to Preparation Example 1 was mixed thereto such that a content of the boehmite was 95 wt %, and water was added such that the total solid content was 25 wt %, thereby forming a composition for forming an inorganic layer.

By using a gravure coating method, the prepared composition for forming an inorganic layer was applied onto a cross section of a 5.5 μm thick polyethylene single-layer base film used as a porous substrate and then dried for 10 seconds under conditions of a drying temperature of 70 °C and a wind speed of 15 m/sec, thereby preparing a separator including an inorganic layer with a coating thickness of 2 μm.

Separately, a poly(butylmethacrylate-co-ethyleneglycol dimethacrylate) copolymer (2550M manufactured by Zeon Corporation) as first particles and a poly(styrene-co-ethylhexylacrylate-acrylonitrile) copolymer (SP-18A manufactured by Zeon Corporation) as second particles were mixed at a weight ratio of 5.13:1, and then a polyacrylic acid (PAA) compound (AQC manufactured by Sumitomo Chemical Co., Ltd) was added and mixed thereto to form a composition for forming an adhesive layer. A content of the PAA compound is about 2 wt % with respect to 100 wt % of the total weight of the composition for forming an adhesive layer.

In the poly(butylmethacrylate-co-ethyleneglycol dimethacrylate) copolymer, a mixing molar ratio of butylmethacrylate to ethyleneglycol dimethacrylate is 8:2, and in the poly(styrene-co-ethylhexylacrylate-acrylonitrile) copolymer, a mixing molar ratio of styrene, ethylhexylacrylate, and acrylonitrile is 8:5:0.1.

By using a gravure coating method, a coating composition for forming the adhesive layer was applied onto a porous substrate of the separator, which included the organic layer (thickness: 2 μm) and was prepared according to such a process, and dried for 10 seconds under conditions of a drying temperature of 60 °C and a wind speed of 15 m/sec, thereby forming a (double-sided) adhesive layer with 1.0 g/m² on the inorganic layer to form a separator.

An inorganic layer and an adhesive layer were each formed on the other side of the porous substrate according to the method described above to prepare a separator having a stacked structure of an adhesive layer/inorganic layer/porous substrate/inorganic layer/adhesive layer.

### Example 2: Separator Having Stacked Structure of Adhesive Layer/Inorganic Layer/Porous Substrate/Inorganic Layer/Adhesive Layer

A poly(butylmethacrylate-co-ethyleneglycol dimethacrylate) copolymer (2550 manufactured by Zeon Corporation) as first particles and a 780 nm-sized poly(styrene-co-ethylhexylacrylate-acrylonitrile) structure copolymer (SP-18B manufactured by Zeon Corporation) as second particles were mixed at a weight ratio of 1.97:1, and then a PAA compound (AQC manufactured by Sumitomo Chemical Co., Ltd) was used at 2 wt % of a total weight ratio, thereby forming a composition for forming an adhesive layer. The coating and drying of the adhesive layer and the coating layer was performed in the same manner as in Example 1 to prepare a separator.

### Example 3: Separator Having Stacked Structure of Adhesive Layer/Inorganic Layer/Porous Substrate/Inorganic Layer/Adhesive Layer

A poly(butylmethacrylate-co-ethyleneglycol dimethacrylate) copolymer (2550M manufactured by Zeon Corporation) as first particles and a poly(styrene-co-ethylhexylacrylate-acrylonitrile) copolymer (SP-18A manufactured by Zeon Corporation) as second particles were mixed at a weight ratio of 1.97:1, and then a PAA compound (AQC manufactured by Sumitomo Chemical Co., Ltd) was used at 2 wt % of a total weight ratio, thereby forming a composition for forming an adhesive layer. The coating and drying of the composition for forming an adhesive layer were performed in the same manner as in Example 1 to prepare a separator.

### Example 4: Separator Having Stacked Structure of Adhesive Layer/Porous Substrate/Inorganic Layer/Adhesive Layer

A separator was formed in the same manner as in Example 1, except that a composition for forming an adhesive layer was prepared under conditions shown in Table 1 below and was applied onto the other side of a porous substrate, on which an inorganic layer and an adhesive layer were sequentially formed, and dried to form an adhesive layer on the other side of the porous substrate. A stacked structure of the separator was a stacked structure of an adhesive layer/porous substrate/inorganic layer/adhesive layer.

### Comparative Example 1: Separator Having Stacked Structure of Adhesive Layer/Inorganic Layer/Porous Substrate/Inorganic Layer/Adhesive Layer

A PAA compound (AQC manufactured by Sumitomo Chemical Co., Ltd) was used at 2 wt % of a total weight ratio in a poly(butylmethacrylate-co-ethyleneglycol dimethacrylate) copolymer (2550M manufactured by Zeon Corporation) as first particles, thereby forming a composition for forming an adhesive layer. The coating and drying of the composition for forming an adhesive layer were performed in the same manner as in Example 1 to prepare a separator.

### Comparative Example 2: Separator Having Stacked Structure of Adhesive Layer/Inorganic Layer/Porous Substrate/Inorganic Layer/Adhesive Layer

A PAA compound (AQC manufactured by Sumitomo Chemical Co., Ltd) was applied at 2 wt % of a total weight ratio in a 500 nm-sized poly(styrene-co-ethylhexylacrylate-acrylonitrile) structure copolymer (SP-18B manufactured by Zeon Corporation) as second particles, thereby preparing a composition for forming an adhesive layer. The coating and drying of the composition for forming an adhesive layer were performed in the same manner as in Example 1 to prepare a separator.

### Comparative Example 3: Separator Having Stacked Structure of Adhesive Layer/Inorganic Layer/Porous Substrate/Inorganic Layer/Adhesive Layer

A poly(butylmethacrylate-co-ethyleneglycol dimethacrylate) copolymer (2550M manufactured by Zeon Corporation) as first particles and a 870 nm-sized poly(styrene-co-ethylhexylacrylate-acrylonitrile) structure copolymer (SP-18C manufactured by Zeon Corporation) as second particles were mixed at a weight ratio of 1.97:1, and then a PAA compound (AQC manufactured by Sumitomo Chemical Co., Ltd) was used at 2 wt % of a total weight ratio, thereby preparing a composition for forming an adhesive layer. The coating and drying of the composition for forming an adhesive layer were performed in the same manner as in Example 1 to prepare a separator.

### Comparative Example 4: Separator Having Stacked Structure of Adhesive Layer/Inorganic Layer/Porous Substrate/Inorganic Layer/Adhesive Layer

A separator was prepared in the same manner as in Example 1, except that a volume ratio of an organic filler as first particles to an adhesive binder as second particles was changed to 8:1.

### Comparative Example 5: Separator Having Stacked Structure of Adhesive Layer/Inorganic Layer/Porous Substrate/Inorganic Layer/Adhesive Layer

An adhesive layer and a separator including the same were prepared in the same manner as in Example 1, except that when a composition for forming an adhesive layer was prepared, a mixing volume ratio of first particles to second particles was changed to 1:4.

### Comparative Example 6: Separator Having Stacked Structure of Adhesive Layer/Inorganic Layer/Porous Substrate/Inorganic Layer/Adhesive Layer

An adhesive layer and a separator including the same were prepared in the same manner as in Example 1, except that when a composition for forming an adhesive layer was prepared, a mixing volume ratio of first particles to second particles was changed to 9:1.

TABLE 1

| | | | | | | | Comparative |
|---|---|---|---|---|---|---|---|
| Classification [symbol] | | | Example 1 [symbol] | Example 2 [symbol] | Example 3 [symbol] | Example 4 [symbol] | Example 1 [symbol] |
| Composition [symbol] | First particles [symbol] | Organic filler (250 nm) [symbol] | [symbol] 2 [symbol] | 65 [symbol] | 65 [symbol] | 65 [symbol] | 98 [symbol] |
| | Second particles [symbol] | Adhesive binder (500 nm) [symbol] | 16 [symbol] | — [symbol] | 33 [symbol] | 33 [symbol] | 9 [symbol] |
| | | Adhesive binder (780 nm) [symbol] | — [symbol] | 33 [symbol] | — [symbol] | [symbol] | — [symbol] |
| | | Adhesive binder (870 nm) [symbol] | — [symbol] | — [symbol] | — [symbol] | [symbol] | — [symbol] |
| | | Adhesive binder (410 nm) [symbol] | [symbol] | [symbol] | [symbol] | [symbol] | [symbol] |
| | | Adhesive binder (525 nm) [symbol] | [symbol] | [symbol] | [symbol] | [symbol] | [symbol] |
| | Others [symbol] | PAA compound [symbol] | 2 [symbol] | 2 [symbol] | 2 [symbol] | 2 [symbol] | 2 [symbol] |

| | | | | | | |
|---|---|---|---|---|---|---|
| Mixing ratio [symbol] | Volume ratio of first particles second | 1:8 [symbol] | 1:30 [symbol] | 1:8 [symbol] | 1:8 [symbol] | — [symbol] |
| | particles [symbol] | | | | | |
| [symbol] | Diameter ratio of first particles second | 1:2 [symbol] | 1:3.1 [symbol] | 1:2 [symbol] | 1:2 [symbol] | — [symbol] |
| | particles [symbol] | | | | | |

| | | | | | Comparative | | |
|---|---|---|---|---|---|---|---|
| | | | Comparative | Comparative | Example [symbol] | Comparative | Comparative |
| Classification [symbol] | | | Example 2 [symbol] | Example 3 [symbol] | 4 [symbol] | Example 5 [symbol] | Example 6 [symbol] |
| Composition [symbol] | First particles [symbol] | Organic filler (250 nm) [symbol] | 0 [symbol] | 65 [symbol] | 33 [symbol] | 65 [symbol] | 65 [symbol] |
| | Second particles [symbol] | Adhesive binder (500 nm) [symbol] | 98 [symbol] | — [symbol] | 65 [symbol] | [symbol] | [symbol] |
| | | Adhesive binder (780 nm) [symbol] | — [symbol] | — [symbol] | — [symbol] | [symbol] | [symbol] |
| | | Adhesive binder (870 nm) [symbol] | — [symbol] | 33 [symbol] | — [symbol] | [symbol] | [symbol] |
| | | Adhesive binder (410 nm) [symbol] | [symbol] | [symbol] | [symbol] | 33 [symbol] | [symbol] |
| | | Adhesive binder (525 nm) [symbol] | [symbol] | [symbol] | [symbol] | [symbol] | 33 [symbol] |
| | Others [symbol] | PAA compound [symbol] | 2 [symbol] | 2 [symbol] | 2 [symbol] | [symbol] | [symbol] |

| | | | | | | |
|---|---|---|---|---|---|---|
| Mixing ratio [symbol] | Volume ratio of first particles second | — [symbol] | 1:42 [symbol] | 8:1 [symbol] | 1:4 [symbol] | 9:1 [symbol] |
| | particles [symbol] | | | | | |
| [symbol] | Diameter ratio of first particles second | — [symbol] | 1:3.5 [symbol] | 2:1 [symbol] | 1:1.6 [symbol] | 2.1:1 [symbol] |
| | particles [symbol] | | | | | |

[symbol]

indicates data missing or illegible when filed

In Table 1, poly(butylmethacrylate-co-ethyleneglycol dimethacryatel) is used as an organic filler (size: 250 nm) (2550M manufactured by Zeon Corporation), SP-18A (manufactured by Zeon Corporation) is used as an organic adhesive binder (500 nm) and is a copolymer with a poly(styrene-co-ethylhexylacrylate-acrylonitrile) structure, and a mixing molar ratio of styrene, ethylhexylacrylate, and acrylonitrile is 8:2:0.5.

SP-18B (manufactured by Zeon Corporation) is used as an organic adhesive binder (size: 780 nm) and is a (styrene-co-ethylhexylacrylate-acrylonitrile) copolymer, and a mixing molar ratio of styrene, ethylhexylacrylate, and acrylonitrile is 8:2:0.5.

SP-18C (manufactured by Zeon Corporation) is used as an organic adhesive binder (size: 870 nm) and is (styrene-co-ethylhexylacrylate-acrylonitrile) copolymer, and a mixing molar ratio of styrene, ethylhexylacrylate, and acrylonitrile is 8:2:0.5.

AQC (manufactured by Sumitomo Chemical Co., Ltd) is used as a PAA-containing compound and has a weight average molecular weight of about 450,000, and a size of each particle in Table 1 refers to D50. In the composition of Table 1, values of the first particles, the second particles, and others refer to parts by weight.

### Manufacturing of Lithium Battery

### Manufacturing Example 1

### (Preparation of Anode)

An anode was prepared according to the following process.

97 wt % of graphite particles with an average particle diameter of 25 μm, 1.5 wt % of styrene-butadiene rubber (SBR) binder, and 1.5 wt % of carboxymethyl cellulose (CMC) were mixed, added to distilled water, and then stirred for 60 minutes by using a mechanical stirrer to prepare an anode active material slurry. The slurry was applied onto a 10 μm thick copper current collector by using a doctor blade, dried in a hot air dryer at a temperature of 100 °C for 0.5 hours, dried once again for 4 hours under conditions of vacuum and a temperature of 120 °C, and then roll-pressed to prepare the anode.

### (Preparation of Cathode)

Separately, a cathode was prepared according to the following process. 97 wt % of LiCoO₂, 1.5 wt % of a carbon black powder as a conductive material, and 1.5 wt % of polyvinylidene fluoride (PVDF) were mixed, added to an N-methyl-2-pyrrolidone solvent, and then stirred for 30 minutes by using a mechanical stirrer to prepare a cathode active material slurry. The slurry was applied onto a 20 μm thick aluminum current collector by using a doctor blade, dried in a hot air dryer at a temperature of 100 °C for 0.5 hours, dried once again for 4 hours under conditions of vacuum and a temperature of 120 °C, and then roll-pressed to prepare the cathode.

### (Electrode Assembly Jelly Roll)

The separator obtained according to Example 1 was interposed between the cathode and the anode prepared above and then wound to prepare an electrode assembly jelly roll. The jelly roll was inserted into a pouch, an electrolyte was injected, and then the pouch was vacuum-sealed.

As the electrolyte, a solution, in which 1.3M LiPF₆ was dissolved in a mixed solvent of ethylene carbonate (EC), ethylmethyl carbonate (EMC), and diethyl carbonate (DEC) having a volume ratio of 3:5:2, was used.

A pressure of 11.7 kgf/cm² was applied to press the jelly roll inserted into the pouch at a temperature of 80 °C for 3 minutes, thereby manufacturing a lithium battery.

### Manufacturing Examples 2 to 4

Lithium batteries were manufactured in the same manner as in Manufacturing Example 1, except that the separators of Examples 2 to 4 were each used instead of the separator of Example 1.

### Comparative Manufacturing Examples 1 to 6

Lithium batteries were manufactured in the same manner as in Manufacturing Example 1, except that the separators of Comparative Examples 1 to 6 were each used instead of the separator of Example 1.

### Evaluation Example 1: Air Permeability

According to Examples 1 to 4 and Comparative Examples 1 to 6, a unit thickness of each separator was measured by using an air permeability tester (Asahi Seiko OKEN Type Air Permeation Tester: EGO1-55-1 MR) according to the following method.

After 10 specimens cut at 10 different points to a size capable of accommodating a circle with a diameter of 1 inch were prepared, Asahi Seiko OKEN Type Air Permeation Tester EG01-55-1MR (manufactured by Asahi Seiko Co., Ltd.), which was an air permeability measuring device, was used to measure a time required for 100 cc of air to pass through each specimen. After the time was measured five times, an average value was calculated to measure air permeability.

Setting conditions of the air permeability tester include measurement pressure: 0.05 mPa, cylinder pressure: 2.5 kg/cm², and set time: 10 seconds. A 1 m specimen was measured at least 10 times at 10 cm intervals, and an average value of data was recorded.

In Table 2 below, Δ air permeability (sec/100 cc) denotes a change in air permeability, which is represented by the following equation.

Δ air permeability=(separator air permeability after test)−(initial separator air permeability). Equation 1

Air permeability test conditions are as follows.
Heat Press (HP): 80 °C/300 kgf/1 hr
Cold Press (CP): 25 °C/300 kgf/1 min

### Evaluation Example 2: Resistance

The resistance of each of the separators of Examples 1 to 4 and Comparative Examples 1 to 6 was evaluated by measuring AC impedance. Evaluation results are shown in Table 2 below.

### Evaluation Example 3: Bending Strength

The bending strength of each of the lithium batteries manufactured according to Manufacturing Examples 1 to 5 and Comparative Manufacturing Examples 1 to 6 was measured to investigate the bending strength of a pouch-type battery. In each lithium battery, the bending strength was measured by measuring the adhesion (bending strength) between a cathode active material layer and a separator by using a 3-point bending method.

Results of evaluating the bending strength are shown in Table 2.

### Evaluation Example 4: Lifespan Characteristics

In the lithium secondary batteries manufactured according to Manufacturing Examples 1 to 4 and Comparative Manufacturing Examples 1 to 6, charge/discharge characteristics were evaluated by using a charging/discharging device (model: TOYO-3100 manufactured by TOYO).

In first charging/discharging, constant current charging was performed at a current of 0.1 C until a voltage reached 4.4 V, and then constant voltage charging was performed at a current of 0.05 C until a current reached a current of 0.05 C. Charged cells were rested for about 10 minutes and then were discharged at a constant current of 0.1 C until a voltage reached 3 V. In a second charging/discharging cycle, constant current charging was performed with a current of 0.2 C until a voltage reached 4.2 V, and then constant voltage charging was performed until a current reached 0.05 C. Charged cells were rested for about 10 minutes and then were discharged at a constant current of 0.2 C until a voltage reached 3 V.

For lifespan evaluation, constant current charging was performed at a current of 1 C until a voltage reached 4.4 V, and then constant voltage charging was performed until a current reached 0.05 C. Charged cells were rested for about 10 minutes and discharged at a constant current of 1 C until a voltage reached 3 V, and such a cycle was repeated 500 times to evaluate lifespan characteristics.

Results of evaluating a lifespan are shown in Table 2 below.

The lifespan is evaluated according to Equation 2 below.

lifespan=(discharge capacity at 500^{th} cycle/discharge capacity at first cycle)×100 Equation 2

### Evaluation Example 5: Adhesion to Porous Substrate (Hereinafter Referred to as Substrate Adhesion)

By using a universal testing machine (manufactured by Instron), a test was performed according to Korean Industrial Standard KS-A-01107 (Testing Method for Adhesive Tapes and Adhesive Sheets). Each of the separators prepared in Examples and Comparative Examples was cut to 25 mm in width and 250 mm in length, tape (Nitto 31B) was attached to each of two sides to prepare a specimen, and the specimen was pressed by reciprocating once at a speed of 300 mm/min using a pressing roller with a load of 2 kg. After 30 minutes of pressing, the specimen was turned over 180°, about 25 mm of the specimen was peeled off, and then the separator and the tape attached to one side of the separator were fixed to an upper clip of a tensile tester (Instron Series 1X/s Automated materials Tester-3343 manufactured by Instron). The tape attached to the other side of the separator was fixed to a lower clip and then pulled at a tensile speed of 60 mm/min to measure pressure when a porous adhesive layer is peeled off of a porous substrate.

TABLE 2

| | | | | | Comparative |
|---|---|---|---|---|---|
| Classification [symbol] | Example 1 [symbol] | Example 2 [symbol] | Example 3 [symbol] | Example 4 [symbol] | Example 1 [symbol] |
| Air permeability | 142 [symbol] | 147 [symbol] | 147 [symbol] | 152 [symbol] | 140 [symbol] |
| (sec/100 cc) [symbol] | | | | | |
| Membrane resistance | 0.74 [symbol] | 0.75 [symbol] | 0.75 [symbol] | 0.79 [symbol] | 0.72 [symbol] |
| (Ω) [symbol] | | | | | |
| Lifespan (500 [symbol] ) [symbol] | 95% [symbol] | 96% [symbol] | 96% [symbol] | 94% [symbol] | 30% [symbol] |
| Bending strength (N) [symbol] | 425 [symbol] | 456 [symbol] | 441 [symbol] | 421 [symbol] | 45 [symbol] |
| Substrate adhesion | 0.7 [symbol] | 0.8 [symbol] | 0.8 [symbol] | 0.7 [symbol] | 0.02 [symbol] |
| (N/mm) [symbol] | | | | | |
| Δ Air permeability | 154 [symbol] | 167 [symbol] | 165 [symbol] | 89 [symbol] | 49 [symbol] |
| (sec/100 cc) [symbol] | | | | | |
| | Comparative | Comparative | Comparative | Comparative | Comparative |
| Classification [symbol] | Example 2 [symbol] | Example 3 [symbol] | Example 4 [symbol] | Example 5 [symbol] | Example 6 [symbol] |
| Air permeability | 315 [symbol] | 201 [symbol] | 178 [symbol] | 167 [symbol] | 227 [symbol] |
| (sec/100 cc) [symbol] | | | | | |
| Membrane resistance | 1.3 [symbol] | 0.85 [symbol] | 0.87 [symbol] | 0.8 [symbol] | 1.06 [symbol] |
| (Ω) [symbol] | | | | | |
| Lifespan (500 [symbol] ) [symbol] | 34% [symbol] | [symbol] 1% [symbol] | 68% [symbol] | [symbol] 4% [symbol] | 1% [symbol] |
| Bending strength (N) [symbol] | 445 [symbol] | 412 [symbol] | 217 [symbol] | 317 [symbol] | 398 [symbol] |
| Substrate adhesion | 0.8 [symbol] | 0.8 [symbol] | 0.1 [symbol] | 0.7 [symbol] | 0.8 [symbol] |
| (N/mm) [symbol] | | | | | |
| Δ Air permeability | 540 [symbol] | 298 [symbol] | 398 [symbol] | 315 [symbol] | 482 [symbol] |
| (sec/100 cc) [symbol] | | | | | |

[symbol]

indicates data missing or illegible when filed

Referring to Table 2, it could be seen that the lithium batteries of Manufacturing Examples 1 to 4 respectively adopting the separators of Examples 1 to 4 had considerably improved lifespan characteristics as compared to the lithium batteries of Comparative Manufacturing Examples 1 to 6 respectively including the separators of Comparative Examples 1 to 6.

Although the separator of Comparative Example 1 had excellent membrane resistance, the separator had poor bending strength and substrate adhesion and thus was difficult to actually apply, and the lifespan characteristics of lithium batteries adopting the separator were considerably reduced as compared to Examples 1 to 4. Although the separator of Comparative Example 2 had excellent bending strength and substrate adhesion, the separator exhibited poor membrane resistance, and also the lifespan characteristics of lithium batteries adopting the separator were considerably reduced as compared to Examples 1 to 4.

The separator of Comparative Example 3 has a lower lifespan and higher air permeability as compared to the Examples, and the separator of Comparative Example 4 has poor adhesion to a substrate, which makes it difficult to expect the strong adhesion between an electrode and an adhesive layer. The separator of Comparative Example 5 has low bending strength, which has a lower lifespan and higher air permeability as compared to the Examples, and the separator of Comparative Example 6 has poor membrane resistance characteristics and the lifespan characteristics of lithium batteries adopting the separator are very poor, which makes it difficult to actually apply the separator. From these results, it could be seen that a lithium battery with improved lifespan characteristics could be manufactured by controlling a volume ratio of first particles to second particles in an adhesive layer of each of the separators of Examples 1 to 4 to strongly control the adhesion between an electrode and the separator.

While one or more embodiments have been described with reference to the drawings and Examples, the description merely illustrates, and it will be understood by those of ordinary skill in the art that various modifications and other equivalent embodiments are possible therefrom. Therefore, the protection scope of the disclosure should be defined by the appended claims.

While the disclosure has seen described with reference to embodiments, it will be understood by those of ordinary skill in the art that various changes and modifications may be made therein without departing from the spirit and scope by the following claims.

1. A separator for a secondary battery, the separator comprising:
a porous substrate;
an inorganic layer positioned on at least one side of the porous substrate; and
an adhesive layer positioned on the inorganic layer,
wherein the adhesive layer contains first particles and second particles which are organic binders with different particle sizes, and
a mixing volume ratio of the first particles to the second particles is in a range of 1:5 to 1:35.

2. The separator of claim 1, wherein the first particles have a smaller size than the second particles, and the first particles have a size of 100 nm to 300 nm.

3. The separator of claim 1, wherein the second particles have a size of 500 nm to 900 nm.

4. The separator of claim 1, wherein a thermal decomposition temperature of the first particles is 200 °C or more.

5. The separator of claim 1, wherein a glass transition temperature of the second particles is in a range of 40 °C to 80 °C.

6. The separator of claim 1, wherein a total content of the first particles and the second particles is in a range of 60 parts by weight to 98 parts by weight with respect to 100 parts by weight of a total weight of the adhesive layer.

7. The separator of claim 1, wherein the first particles and the second particles each independently comprise a butylmethacrylate-ethyleneglycol dimethacrylate copolymer, a butylmethacrylate-ethyleneglycol dimethacrylate-acrylonitrile copolymer, a styrene-ethylhexylacrylate copolymer, a styrene-ethylhexylacrylate-acrylonitrile copolymer, styrene-butadiene rubber, acrylated styrene-butadiene rubber, acrylonitrile-butadiene rubber, acrylonitrile-butadiene-styrene rubber, acrylic rubber, butyl rubber, fluoro rubber, polytetrafluoroethylene, polyethylene, polypropylene, an ethylene propylene copolymer, polyethylene oxide, polyvinylpyrrolidone, polyepichlorohydrin, polyphosphazene, polyacrylate, polyacrylonitrile, polystyrene, an ethylene propylene diene copolymer, polyvinylpyridine, chlorosulfonated polyethylene, latex, a polyester resin, an acrylic resin, a phenol resin, an epoxy resin, polyvinyl alcohol, carboxymethyl cellulose, hydroxypropyl methyl cellulose, hydroxypropyl cellulose, diacetyl cellulose, or a combination thereof.

8. The separator of claim 1, wherein the first particles are a polymer obtained from a polymerizable monomer having a crosslinkable functional group,
wherein the crosslinkable functional group is a glycidyl group, an amino group, an N-methylol group, or a vinyl group.

9. The separator of claim 8, wherein the polymerizable monomer having the crosslinkable functional group is hydroxy ester of ethylenic unsaturated carboxylic acid, glycidyl ester of ethylenic unsaturated carboxylic acid, glycidyl ester, amino ester of ethylenic unsaturated carboxylic acid, methylol group-containing ethylenic unsaturated amide, a monomer having two or more vinyl groups, or a combination thereof.

10. The separator of claim 9, wherein the hydroxy ester of ethylenic unsaturated carboxylic acid comprises hydroxypropyl (meth)acrylate, hydroxyethyl (meth)acrylate, or a combination thereof, the glycidyl ester of ethylenic unsaturated carboxylic acid comprises glycidyl (meth)acrylate, the amino ester of ethylenic unsaturated carboxylic acid comprises dimethylamino ethyl (meth)acrylate, the methylol group-containing ethylenic unsaturated amide comprises N-methylol(meth)acrylamide, N,N-dimethylol(meth)acrylamide, or a combination thereof, and
the monomer having the two or more vinyl groups comprises ethylene di(meth)acrylate, divinylbenzene, or a combination thereof.

11. The separator of claim 1, wherein the separator comprises an adhesive layer or an inorganic layer disposed on the other side of the porous substrate.

12. The separator of claim 11, wherein a volume ratio of the first particles to the second particles in the adhesive layer is in a range of 1:8 to 1:40.

13. The separator of claim 1, wherein the adhesive layer further comprises at least one adhesive binder selected from a fluorine-based resin, a polyacrylic acid-based compound, and a (meth)acrylic resin.

14. The separator of claim 13, wherein the fluorine-based resin is polyvinylidene fluoride, a polyvinylidene fluoride-hexafluoropropylene copolymer, a polyvinylidene fluoride-trichloroethylene copolymer, a polyvinylidene fluoride-chlorotrifluoroethylene copolymer, or a combination thereof, the polyacrylic acid-based compound is a polyacrylic acid, a polymethylacrylic acid, a polyethylacrylic acid, a polybutylacrylic acid, a polyhexyl acrylic acid, a polyhydroxyethyl methacrylic acid, a polyaminoacrylic acid, or a combination thereof, and the (meth)acrylic resin is polyacrylate, polymethacrylate, polybutylacrylate, polyacrylonitrile, or a combination thereof.

15. The separator of claim 1, wherein an adhesive layer is disposed on the other side of the porous substrate, and
the separator further comprises an inorganic layer between the adhesive layer and the porous substrate.

16. The separator of claim 15, wherein the inorganic layer comprises inorganic particles and a binder,
wherein the inorganic particles comprise Al2O3, SiO2, B2O3, Ga2O3, TiO2, SnO2, boehmite, BaSO4, MgO, Mg(OH)2, clay, ZnO, CaO, CeO2, NiO, GaO, ZrO2, Y2O3, SrTiO3, BaTiO3, or a combination thereof.

17. The separator of claim 16, wherein a content of the inorganic particles is in a range of 50 parts by weight to 95 parts by weight with respect to 100 parts by weight of a total weight of the inorganic layer.

18. The separator of claim 16, wherein the binder is a crosslinkable binder, a non-crosslinkable binder, or a combination thereof,
wherein the non-crosslinkable binder is at least one selected from the group consisting of a polyvinylidene fluoride (PVDF)-based polymer, polymethyl methacrylate, polyacrylonitrile, polyvinylpyrrolidone, polyvinyl acetate, polyethylene oxide, cellulose acetate, cellulose acetate butyrate, cellulose acetate propionate, cyanoethyl pullulan, cyanoethyl polyvinyl alcohol, cyanoethyl cellulose, cyanoethyl sucrose, pullulan, carboxymethyl cellulose, and an acrylonitrile-butadiene-styrene copolymer, or a mixture thereof.

19. The separator of claim 18, wherein the crosslinkable binder is poly(acrylic acid-co-acrylamide-co-2-acrylamido-2-methylpropanesulfonic acid), a polyacrylamide-acrylic acid-hydroxyethyl acrylic copolymer, or a combination thereof.

20. A secondary battery comprising a cathode, an anode, and the separator of claim 1 which is interposed between the cathode and the anode.
